(19) United States
(12) Patent Application Publication
(10) Pub. No.: US 2025/0388473 A1
(43) Pub. Date: Dec. 25, 2025

(54) GRAPHENE QUANTUM DOTS FROM CARBON MATERIALS

(71) Applicant: Lyten, Inc., San Jose, CA (US)

(72) Inventors: Parth Patel, Newark, CA (US); Beomseok Kim, Hayward, CA (US); George Clayton Gibbs, Santa Clara, CA (US)

(21) Appl. No.: 18/968,733

(22) Filed: Dec. 4, 2024

Related U.S. Application Data
(60) Provisional application No. 63/605,989, filed on Dec. 4, 2023.

(51) Int. Cl. C01B 32/184; B01D 8/00; B01D 15/34; B01D 21/26; B82Y 15/00; B82Y 20/00; B82Y 40/00; C01B 32/196; C01B 32/198; C09K 11/65

(52) U.S. Cl. CPC C01B 32/184; B01D 8/00; B01D 15/34; B01D 21/262; C01B 32/196; C01B 32/198; C09K 11/65; B82Y 15/00; B82Y 20/00; B82Y 40/00; C01B 2204/32; C01P 2002/82; C01P 2004/04; C01P 2004/64; C01P 2006/60

(57) ABSTRACT

Methods for synthesizing and processing graphene quantum dots are disclosed. In use, a first mixture is created comprising carbon, wherein the carbon is obtained from a reactor. Next, a second mixture is created comprising the first mixture and toluene. The second mixture is sonicated. Additionally, the sonicated second mixture is filtered to produce a filtrate, wherein the filtrate includes graphene quantum dots. It is recognized that reactor-derived carbonaceous materials may often be simply discarded and considered waste. Thus, the ability to extract quantum dots from such waste provides a pioneering new approach to bringing value to that which has often been overlooked or thrown out.

### CROSS-REFERENCE TO RELATED APPLICATIONS

This application claims priority to U.S. Provisional Patent Application No. 63/605,989, titled “GRAPHENE QUANTUM DOTS”, filed Dec. 4, 2023, which is assigned to the assignee hereof; the disclosures of which is considered part of and is incorporated by reference in this Patent Application.

### FIELD OF THE INVENTION

The present invention relates to quantum dots, and more particularly to graphene quantum dots produced from reactor carbon materials.

### BACKGROUND

Traditional methods for producing graphene quantum dots (GQDs) often involve top-down approaches such as cutting larger graphene sheets or bottom-up synthesis from molecular precursors. However, these methods frequently suffer from low yields, complex processing steps, or the use of harsh chemicals. Additionally, controlling the size, shape, and edge structure of GQDs remains challenging, which can impact their performance in various applications. Further, these methods are demanding and currently very expensive.

For example, current methods (including colloidal synthesis, vapor phase methods, template-assisted, electrochemical, etc.) for synthesizing quantum dots can be expensive, particularly for high-quality production. Notwithstanding the method selected, each often struggles with scalability, uniformity, complex purification processes (which further increases the cost). Further, the practical application of quantum dots may be limited as high yields are currently not feasible.

As such, there is thus a need for addressing these and/or other issues associated with the prior art.

### SUMMARY

In some aspects, the techniques described herein relate to a system for producing graphene quantum dots, including: a reactor configured to generate a carbonaceous material; a sonication device configured to mix the carbonaceous material with a solvent to form a mixture; a filtration device configured to filter the sonicated mixture; and a collection vessel configured to receive a filtrate containing graphene quantum dots from the filtration device.

In some aspects, the techniques described herein relate to a system, wherein the reactor is a thermal reactor.

In some aspects, the techniques described herein relate to a system, wherein the carbonaceous material includes reactor carbon.

In some aspects, the techniques described herein relate to a system, wherein the solvent includes toluene.

In some aspects, the techniques described herein relate to a system, wherein the sonication device includes a water bath sonicator.

In some aspects, the techniques described herein relate to a system, wherein the filtration device includes a 0.2 μm filter.

In some aspects, the techniques described herein relate to a system, further including a dilution device configured to dilute the filtrate to multiple concentrations.

In some aspects, the techniques described herein relate to a system, further including an ultraviolet light source configured to illuminate the diluted filtrate samples.

In some aspects, the techniques described herein relate to a system, further including an evaporation device configured to evaporate solvent from a portion of the filtrate to obtain a residue.

In some aspects, the techniques described herein relate to a system, further including a re-dispersion device configured to re-disperse the residue in isopropyl alcohol.

In some aspects, the techniques described herein relate to a system, further including a transmission electron microscope configured to analyze the re-dispersed mixture.

In some aspects, the techniques described herein relate to a system, wherein the graphene quantum dots have a size between 1-100 nm.

In some aspects, the techniques described herein relate to a system, wherein the graphene quantum dots exhibit fluorescence when exposed to ultraviolet light.

In some aspects, the techniques described herein relate to a system, further including a waste collection vessel configured to collect unwanted components separated from the carbonaceous material.

In some aspects, the techniques described herein relate to a system, wherein the unwanted components include polycyclic aromatic hydrocarbons (PAHs) oils and low molecular weight solids.

In some aspects, the techniques described herein relate to a system, further including a cold trap configured to collect hydrophobic quantum dots.

In some aspects, the techniques described herein relate to a system, further including a dispersion device configured to disperse the hydrophobic quantum dots in a variety of solvents.

In some aspects, the techniques described herein relate to a system, further including a characterization device configured to analyze the graphene quantum dots.

In some aspects, the techniques described herein relate to a system, wherein the characterization device includes a fluorescence spectrometer.

In some aspects, the techniques described herein relate to a system, wherein the characterization device includes an atomic force microscope.

In some aspects, the techniques described herein relate to a system, further including a purification device configured to further purify the graphene quantum dots.

In some aspects, the techniques described herein relate to a system, wherein the purification device includes a centrifuge.

In some aspects, the techniques described herein relate to a system, further including a storage device configured to store the graphene quantum dots under controlled environmental conditions.

In some aspects, the techniques described herein relate to a system, further including a surface functionalization device configured to modify the surface of the graphene quantum dots.

In some aspects, the techniques described herein relate to a system, wherein the surface functionalization device is configured to attach functional groups to the graphene quantum dots.

In some aspects, the techniques described herein relate to a system, further including a size selection device configured to separate graphene quantum dots based on size.

In some aspects, the techniques described herein relate to a system, wherein the size selection device includes a size exclusion chromatography column or a dialysis bag.

In some aspects, the techniques described herein relate to a system, further including a quality control device configured to assess the purity and uniformity of the graphene quantum dots.

In some aspects, the techniques described herein relate to a system, wherein the quality control device includes a dynamic light scattering instrument.

In some aspects, the techniques described herein relate to a system, further including a packaging device configured to prepare the graphene quantum dots for storage or transport.

In some aspects, the techniques described herein relate to a method of producing graphene quantum dots, including: obtaining a carbonaceous material from a reactor; adding a solvent to the carbonaceous material to form a mixture; sonicating the mixture; filtering the sonicated mixture to obtain a filtrate; and collecting the filtrate containing graphene quantum dots.

In some aspects, the techniques described herein relate to a method, wherein the carbonaceous material includes reactor carbon.

In some aspects, the techniques described herein relate to a method, wherein the solvent includes toluene.

In some aspects, the techniques described herein relate to a method, wherein sonicating the mixture is performed using a water bath sonicator.

In some aspects, the techniques described herein relate to a method, wherein filtering the sonicated mixture is performed using a 0.2 μm filter.

In some aspects, the techniques described herein relate to a method, further including diluting the filtrate to multiple concentrations.

In some aspects, the techniques described herein relate to a method, further including observing fluorescence of the diluted filtrate samples under ultraviolet light.

In some aspects, the techniques described herein relate to a method, further including evaporating solvent from a portion of the filtrate to obtain a residue.

In some aspects, the techniques described herein relate to a method, further including re-dispersing the residue in isopropyl alcohol.

In some aspects, the techniques described herein relate to a method, further including analyzing the re-dispersed mixture via transmission electron microscopy.

In some aspects, the techniques described herein relate to a method, wherein the graphene quantum dots have a size between 1-100 nm.

In some aspects, the techniques described herein relate to a method, wherein the graphene quantum dots exhibit fluorescence when exposed to ultraviolet light.

In some aspects, the techniques described herein relate to a method, further including collecting unwanted components separated from the carbonaceous material.

In some aspects, the techniques described herein relate to a method, wherein the unwanted components include polycyclic aromatic hydrocarbons (PAHs) oils and low molecular weight solids.

In some aspects, the techniques described herein relate to a method, further including collecting hydrophobic quantum dots using a cold trap.

In some aspects, the techniques described herein relate to a method, further including dispersing the hydrophobic quantum dots in a variety of solvents.

In some aspects, the techniques described herein relate to a method, further including characterizing the graphene quantum dots using a fluorescence spectrometer.

In some aspects, the techniques described herein relate to a method, further including characterizing the graphene quantum dots using an atomic force microscope.

In some aspects, the techniques described herein relate to a method, further including purifying the graphene quantum dots using a centrifuge.

In some aspects, the techniques described herein relate to a method, further including storing the graphene quantum dots under controlled environmental conditions.

In some aspects, the techniques described herein relate to a method, further including modifying the surface of the graphene quantum dots by attaching functional groups.

In some aspects, the techniques described herein relate to a method, further including separating the graphene quantum dots based on size using a size exclusion chromatography column or a dialysis bag.

In some aspects, the techniques described herein relate to a method, further including assessing the purity and uniformity of the graphene quantum dots using a dynamic light scattering instrument.

In some aspects, the techniques described herein relate to a method, further including packaging the graphene quantum dots for storage or transport.

In some aspects, the techniques described herein relate to a method, wherein the reactor is a thermal reactor.

In some aspects, the techniques described herein relate to a method, further including analyzing the graphene quantum dots using Raman spectroscopy.

In some aspects, the techniques described herein relate to a method, further including functionalizing the graphene quantum dots with biomolecules for biological applications.

In some aspects, the techniques described herein relate to a method, further including incorporating the graphene quantum dots into a polymer matrix.

In some aspects, the techniques described herein relate to a method, further including dispersing the graphene quantum dots in at least one of a non-polar solvent, a polar solvent, or a co-solvent.

In some aspects, the techniques described herein relate to a method, further including treating the graphene quantum dots with an oxidizing agent to modify their surface properties.

### BRIEF DESCRIPTION OF THE DRAWINGS

FIG. 1 illustrates a flowchart for a method of producing and verifying quantum dots from reactor carbon, according to aspects of the present disclosure.

FIG. 2 depicts transmission electron microscopy images of graphene flakes redispersed in isopropyl alcohol, according to an embodiment.

FIG. 3 shows transmission electron microscopy images of nano crystal carbonaceous particles redispersed in isopropyl alcohol, according to aspects of the present disclosure.

FIG. 4 illustrates transmission electron microscopy images of spherical carbonaceous particles redispersed in isopropyl alcohol, according to an embodiment.

FIG. 5 depicts transmission electron microscopy images of flaky carbonaceous particles redispersed in isopropyl alcohol, according to aspects of the present disclosure.

FIG. 6 shows a transmission electron microscopy image of a spherical carbonaceous particle redispersed in isopropyl alcohol, according to an embodiment.

FIG. 7 illustrates a reduced Fast Fourier Transform image of graphene flakesin toluene, according to aspects of the present disclosure.

FIG. 8 depicts transmission electron microscopy images of carbonaceous particles in toluene, according to an embodiment.

FIG. 9 shows transmission electron microscopy images and a Fast Fourier Transform pattern of graphene flakes in toluene, according to aspects of the present disclosure.

FIG. 10 illustrates transmission electron microscopy images and a Fast Fourier Transform pattern of graphene flakes in toluene, according to an embodiment.

FIG. 11 depicts a Fast Fourier Transform pattern of graphene flake in toluene, according to aspects of the present disclosure.

FIG. 12 shows transmission electron microscopy images and a Fast Fourier Transform pattern of graphene flakes in toluene, according to an embodiment.

FIG. 13 illustrates transmission electron microscopy images of carbonaceous particles in water, according to aspects of the present disclosure.

FIG. 14 depicts transmission electron microscopy images of carbonaceous particles in water, according to an embodiment.

FIG. 15 shows transmission electron microscopy images and a Fast Fourier Transform pattern of nano crystal in water, according to aspects of the present disclosure.

FIG. 16 illustrates transmission electron microscopy images and a Fast Fourier Transform pattern of nano crystals in water, according to an embodiment.

FIG. 17 depicts a process flow for reclaiming quantum dots from thermal reactor waste products, according to aspects of the present disclosure.

FIG. 18 shows quantum dot samples under UV light in various solvents, according to an embodiment.

FIG. 19 illustrates quantum dot samples under UV light in toluene, according to aspects of the present disclosure.

FIG. 20A through FIG. 20Y depict structured carbons, various carbon nanoparticles, various carbon-containing aggregates, and various three-dimensional carbon-containing structures that are grown over other materials, according to some embodiments of the present disclosure.

### DETAILED DESCRIPTION

Quantum dots include nanoparticles with unique electronic and optical properties that arise from quantum confinement effects. These nanoscale structures have garnered substantial attention due to their potential applications in a wide range of fields, including electronics, photonics, medicine, and energy.

Historically, in traditional semiconductors, electronic properties may be governed by the bulk material. However, when semiconductor materials are confined to dimensions on the order of the material's exciton Bohr radius, quantum effects may become evident. This quantum confinement may lead to discrete energy levels, which may be evidenced by visible fluorescence.

Notwithstanding the potential for quantum dots, current synthesis methods are unable to overcome issues relating to toxicity, large-scale production, and stability. The methods disclosed herein may be used to overcome such known issues.

Additionally, the present disclosure relates to methods for producing graphene quantum dots from carbonaceous materials. In some aspects, a method for producing graphene quantum dots may include obtaining a carbonaceous material from a reactor. The method may further include adding a solvent to the carbonaceous material to form a mixture. In certain implementations, the solvent may be toluene. The method may also include sonicating the mixture, which in some cases may be performed using a water bath sonicator. Additionally, the method may involve filtering the sonicated mixture to obtain a filtrate containing graphene quantum dots. In some implementations, the filtering may be performed using a 0.2 μm filter.

The methods described herein may provide graphene quantum dots with tunable optical properties. In some aspects, the filtrate containing graphene quantum dots may be diluted to multiple concentrations. The diluted filtrate samples may exhibit fluorescence when exposed to ultraviolet light. In certain implementations, the fluorescence characteristics may vary based on the dilution level.

In some cases, the methods may further include additional processing steps. For example, solvent may be evaporated from a portion of the filtrate to obtain a residue. The residue may then be re-dispersed in a different solvent, such as isopropyl alcohol, toluene, water, etc. The re-dispersed mixture may be suitable for analysis via transmission electron microscopy.

The graphene quantum dots produced by the disclosed methods may have sizes ranging from approximately 1 to 100 nanometers. In some implementations, the graphene quantum dots may be dispersed in various solvents, such as toluene or isopropyl alcohol, depending on the desired application or analysis technique.

The methods described herein may offer advantages in terms of scalability and efficiency for producing graphene quantum dots from reactor-derived carbonaceous materials. The resulting quantum dots may find applications in fields such as bioimaging, sensing, optoelectronics, and energy conversion devices.

Additionally, it is recognized that reactor-derived carbonaceous materials may often be simply discarded and considered waste. Thus, the ability to extract quantum dots from such waste provides a pioneering new approach to bringing value to that which has often been overlooked or thrown out.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

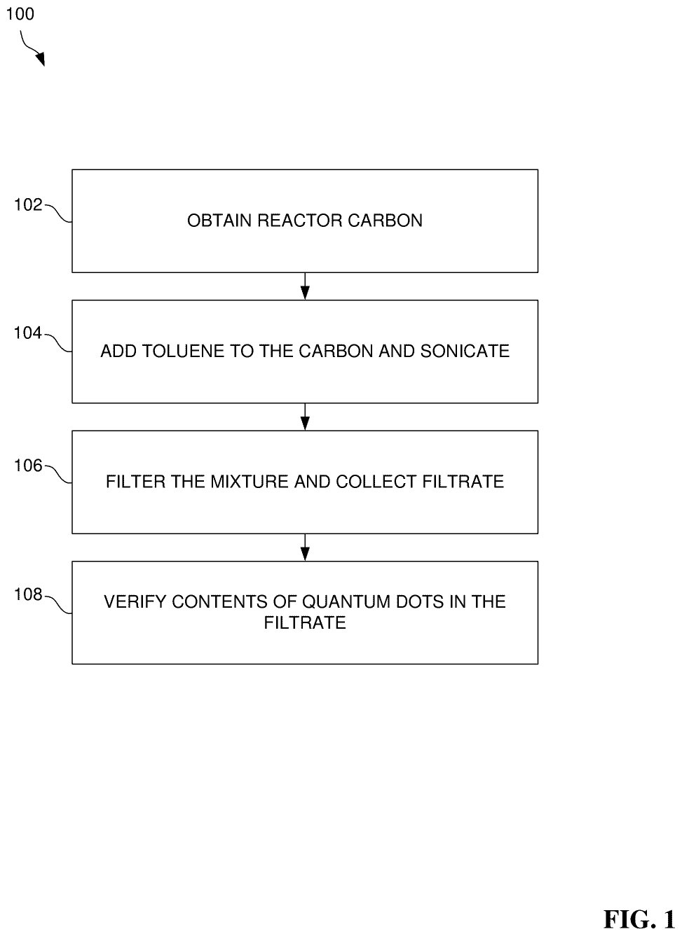

FIG. 1 illustrates a method 100 for synthesizing graphene quantum dots, in accordance with one embodiment.

In some aspects, the method 100 may begin with step 102, which involves obtaining reactor carbon. The reactor carbon may serve as the starting material for producing quantum dots. The specific type and characteristics of the reactor carbon may vary depending on the source and processing conditions.

The method 100 may further include step 104, which involves adding a solvent to the reactor carbon and sonicating the resulting mixture. In some cases, the solvent may be toluene, although other suitable solvents (e.g. isopropyl alcohol, water, etc.) may also be used. The sonication process may be performed using various techniques, such as a water bath sonicator. Sonication may help disperse the carbonaceous material in the solvent and facilitate the formation of quantum dots.

Following sonication, the method 100 may proceed to step 106, which involves filtering the sonicated mixture. In some implementations, the filtering may be performed using a 0.2 μm Teflon filter, although filters with different pore sizes or materials may also be employed. The filtration step may help separate the quantum dots from larger particles or impurities. In one embodiment, the different pore size or materials may be used to isolate particular fraction sizes of quantum dots. For example, different sizes of quantum dots may have different fluorescence color (i.e. it is size-dependent fluorescence, etc.).

The method 100 may then include step 108, which involves collecting the filtrate containing quantum dots. The filtrate obtained after filtration may contain the desired quantum dots suspended in the solvent. This filtrate may be further processed or analyzed to verify the presence and characteristics of the quantum dots.

In some aspects, additional steps may be performed to further process or characterize the quantum dots obtained through the method 100. These steps may include dilution, solvent exchange, and/or various analytical techniques to assess the properties of the quantum dots. In one embodiment, graphene quantum dots may be of size between 1-100 nm.

In practice, reactor carbon (aka raw carbon or uncleaned carbon) may be obtained. To the raw carbon, toluene may be added, and the mixture may be sonicated in a water bath sonicator. After sonication, the mixture may be filtered, such as through a 0.2 μm Teflon filter. The filtrate may then be collected.

With respect to verifying contents of quantum dots in the filtrate, in one embodiment, half of the filtrate may be kept for further analysis via TEM and observed its optical properties using UV LED flashlight (as shown herein in accompanying figures). This filtrate solution may then be serial diluted to a variety of different concentrations in separate vials (e.g. 4 mL vials, etc.) to qualitatively check for fluorescence (which may be a good indication of quantum effect based on carbon particle size).

Based on the foregoing verification, the three different concentrations may be summarized as follows: 1) about half filtrate and half toluene: observed some fluorescence; 2) about quarter filtrate and ¾th toluene: observed distinct green fluorescence; and 3) about 1/10th filtrate and remainder toluene: observed distinct blue fluorescence.

In another embodiment, with respect to the other half of the filtrate, the solvent may be evaporated, and the small amount of gooey red residue may be re-dispersed in isopropyl alcohol with the aid of water bath sonication. Both the toluene mixture and the isopropyl alcohol mixtures may then be analyzed via TEM, as shown hereinbelow in various other figures.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

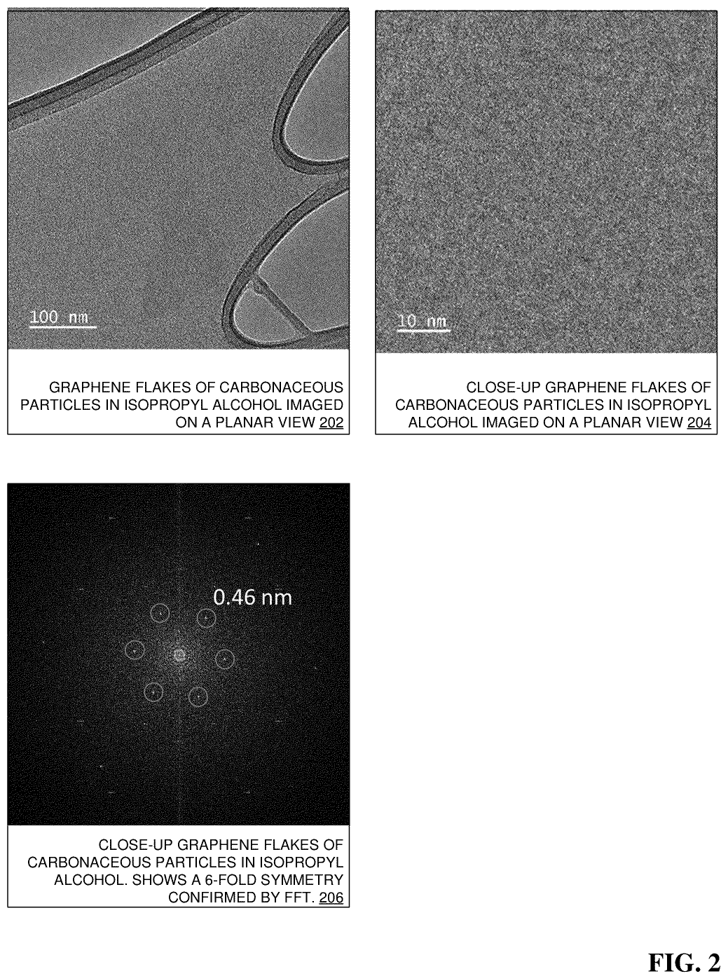

FIG. 2 depicts transmission electron microscopy images of graphene flakes redispersed in isopropyl alcohol, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, transmission electron microscopy (TEM) images of carbonaceous particles dispersed in isopropyl alcohol are illustrated. In some aspects, the carbonaceous particles may include graphene flakes or nano crystal particles. The TEM images provide insights into the structure and morphology of the graphene flakes or nano crystal particles at various magnifications.

In some cases, the graphene flakes may be imaged on a planar view at 100 k× magnification, as shown via image 202. This view may allow for observation of the overall distribution and arrangement of the graphene flakes in the isopropyl alcohol medium. The image 204 displays planar graphene flakes at 1 M× magnification.

In some aspects, the crystalline nature of the graphene flakes may be confirmed through analysis of their atomic structure. The image 206 shows an FFT pattern derived from the close-up view of the graphene flakes. The FFT pattern may reveal a 6-fold symmetry, as indicated by the circular marker at 0.46 nm matching the in-plane spacing for graphene. This 6-fold symmetry may be characteristic of the hexagonal lattice structure of graphene.

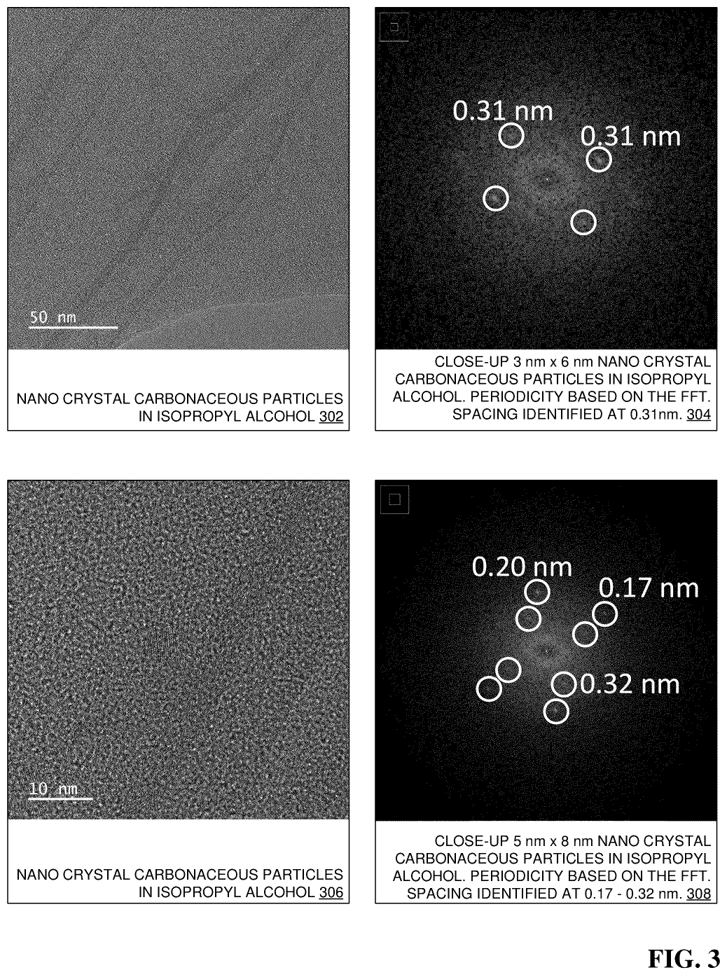

FIG. 3 shows transmission electron microscopy images of nano crystal carbonaceous particles redispersed in isopropyl alcohol, according to aspects of the present disclosure. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

Referring to FIG. 3, transmission electron microscopy (TEM) images of nano crystal carbonaceous particles redispersed in isopropyl alcohol are illustrated. The FIG. comprises multiple images showing the nano crystal carbonaceous particles at different magnifications and with varying levels of detail.

In some aspects, image 302 shows nano crystal carbonaceous particles 302 dispersed in isopropyl alcohol at a scale of 50 nm. The nano crystal carbonaceous particles may appear as small, dark spots distributed throughout the field of view. Image 304 displays a close-up view of a FTT pattern of nano crystal carbonaceous particles, focusing on a 3 nm×6 nm area. The image 304 a Fast Fourier Transform (FFT) pattern, which may indicate periodicity based on spacing identified at 0.31 nm matching that of graphene interlayer spacing.

Image 306 presents another view of nano crystal carbonaceous particles redispersed in isopropyl alcohol at 1 M× magnification. This image may show a denser distribution of the nanoparticles. Additionally, image 308 provides the FFT pattern of a close-up view of nano crystal carbonaceous particles, examining a 5 nm×8 nm area. This image 308 may include an FFT pattern indicating periodicity based on spacing identified between 0.17 and 0.32 nm which match the in-plane and interlayer spacing of graphene, respectively. The presence of distinct spots or patterns in the FFT image may confirm the crystalline structure of the nano crystal carbonaceous particles, including their atomic spacing.

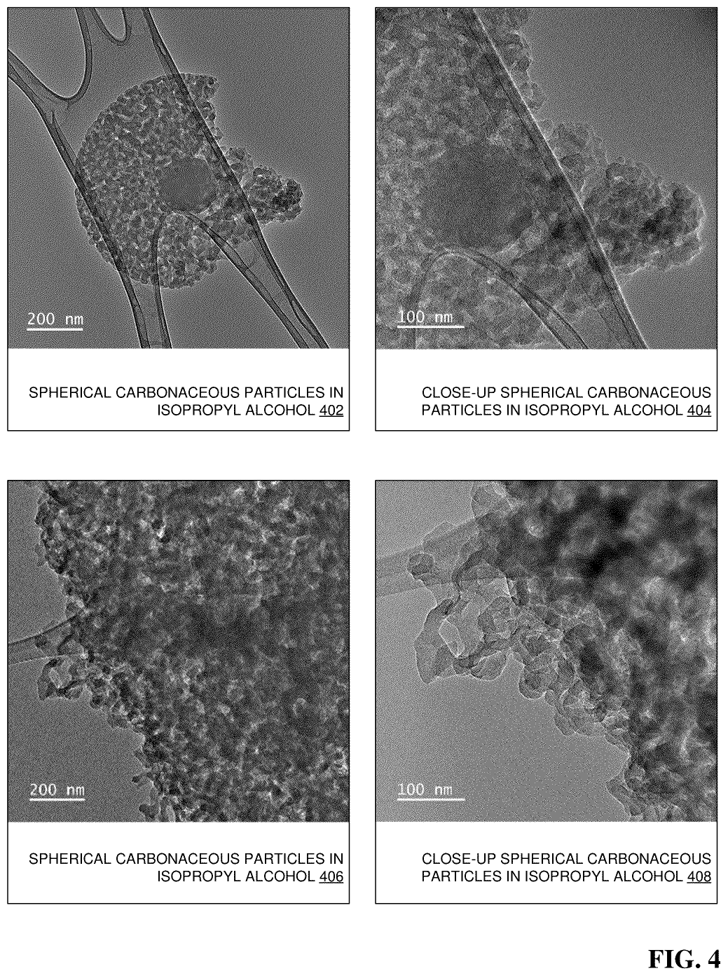

FIG. 4 illustrates transmission electron microscopy images of spherical carbonaceous particles redispersed in isopropyl alcohol, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

Image 402 shows spherical carbonaceous particles redispersed in isopropyl alcohol at 50 k× magnification. In some cases, the spherical carbonaceous particles 402 may appear as a large, irregular cluster with a mottled internal structure. This clustering behavior may be characteristic of the spherical carbonaceous particles when dispersed in isopropyl alcohol. For example, such clustering may result based on solvent-carbon surface interaction. Image 404 provides a close-up view of spherical carbonaceous particles redispersed in isopropyl alcohol at 100 k× magnification.

Image 406 displays another view of spherical carbonaceous particles redispersed in isopropyl alcohol, also at 50 k× magnification. This image may show a larger area of clustered particles, highlighting in particular their tendency to aggregate. In various embodiments, the tendency of the spherical carbonaceous particles to form aggregates may be influenced by factors such as particle size, surface properties, and/or the nature of the dispersion medium. Image 408 presents a close-up view of spherical carbonaceous particles redispersed in isopropyl alcohol at 100 k× magnification.

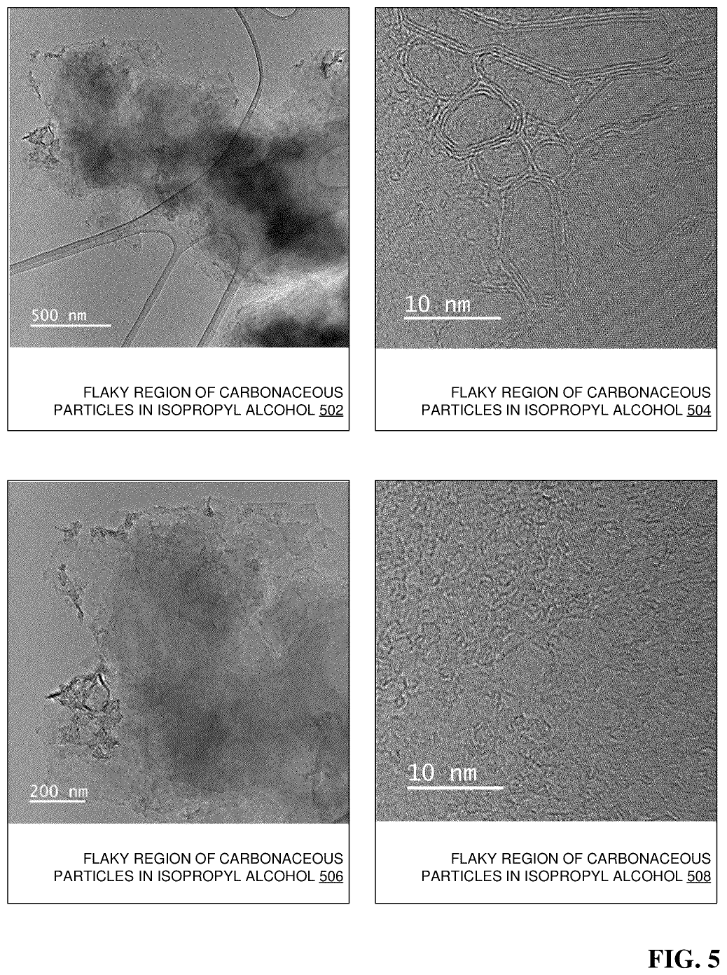

FIG. 5 depicts transmission electron microscopy images of flaky carbonaceous particles redispersed in isopropyl alcohol, according to aspects of the present disclosure. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 502 shows carbonaceous particles at 25 k× magnification. The carbonaceous particles of the image 502 may appear as a cluster with irregular, flaky morphology. In some cases, the particles may form dark, aggregated structures against a lighter background, demonstrating the tendency of these flaky carbonaceous particles to associate with one another in the isopropyl alcohol medium. Image 504 presents carbonaceous particles at 1 M× magnification. This image may display the detailed atomic structure of the carbonaceous particles, potentially revealing lattice fringes and the arrangement of carbon atoms in a graphene-like structure. In some implementations, both ordered regions with clear lattice patterns and more disordered areas may be visible within the carbonaceous particles.

Image 506 of FIG. 5 provides another low magnification view of carbonaceous particles at 50 k× magnification. This image may show a larger flaky region of carbonaceous particles, demonstrating the sheet-like nature of the material. In some cases, the carbonaceous particles may exhibit a layered structure with varying degrees of transparency, which may be indicative of the number of atomic layers present in different regions of the flakes. Further, image 508 offers another view of carbonaceous particles 508 at 1 M× magnification.

In various embodiments, the flaky morphology observed in the carbonaceous particles of the images 502, 504, 506, and/or 508 may be characteristic of graphene-like materials or exfoliated graphite structures. The layered nature of these particles may influence their properties, such as electrical conductivity, mechanical strength, or surface area. It is to be appreciated that the use of other dispersion mediums (toluene, water, etc.) may likewise affect such properties of the particles.

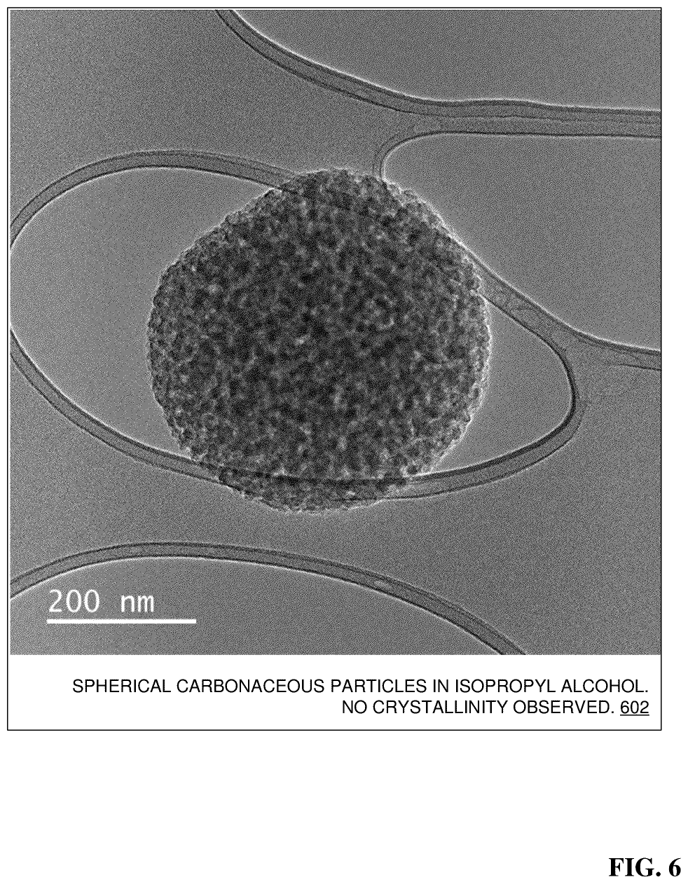

FIG. 6 shows a transmission electron microscopy image of a spherical carbonaceous particle redispersed in isopropyl alcohol, according to an embodiment. As an option, the image may be implemented in the context of any one or more of the embodiments set forth in any previous and/or subsequent figure(s) and/or description thereof. Of course, however, the image may be implemented in the context of any desired environment. Further, the aforementioned definitions may equally apply to the description below.

As shown, a transmission electron microscopy (TEM) image 602 of a spherical carbonaceous particle suspended in isopropyl alcohol is illustrated. In some aspects, the spherical carbonaceous particle of the image 602 may appear as a roughly circular object with a textured surface. The particle may exhibit a porous or granular internal structure, which may be visible as a mottled pattern throughout its volume. This internal structure may suggest a complex arrangement of carbon atoms or smaller carbon-based subunits within the particle.

A scale bar in the lower left corner of the image may indicate a length of 200 nm, providing a reference for the size of the particle. Based on this scale, the diameter of the spherical carbonaceous particle of the image 602 may be estimated to be approximately 400-500 nm. However, the size of spherical carbonaceous particles may vary depending on synthesis conditions and processing methods.

In some implementations, the spherical carbonaceous particle of the image 602 may not exhibit crystallinity, indicating an amorphous carbon structure rather than a highly ordered crystalline arrangement of carbon atoms. This lack of crystallinity may be consistent with the particle's spherical shape and granular internal appearance. In contrast, other arrangements (shown herein) may show a crystalline-type structure and appearance, depending on the solvents and processes used.

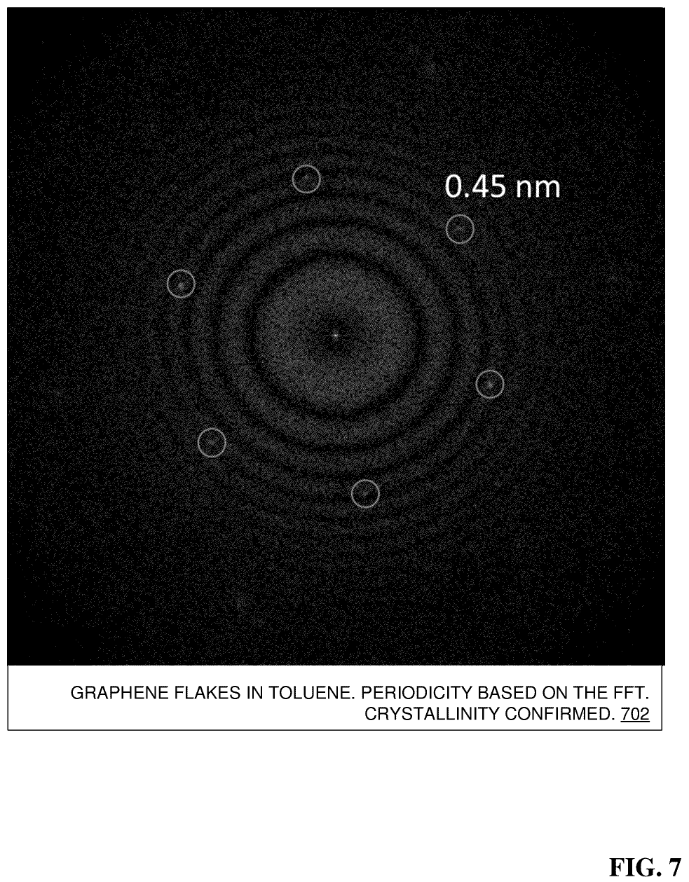

FIG. 7 illustrates a reduced Fast Fourier Transform image of graphene flakes in toluene, according to aspects of the present disclosure. As an option, the image may be implemented in the context of any one or more of the embodiments set forth in any previous and/or subsequent figure(s) and/or description thereof. Of course, however, the image may be implemented in the context of any desired environment. Further, the aforementioned definitions may equally apply to the description below.

As shown, the crystalline nature of the graphene flakes may be confirmed through analysis of their atomic structure. The image 702 shows an FFT pattern derived from the close-up view of the graphene flakes. The FFT pattern may reveal a 6-fold symmetry, as indicated by the circular marker at 0.45 nm matching the in-plane spacing for graphene. This 6-fold symmetry may be characteristic of the hexagonal lattice structure of graphene.

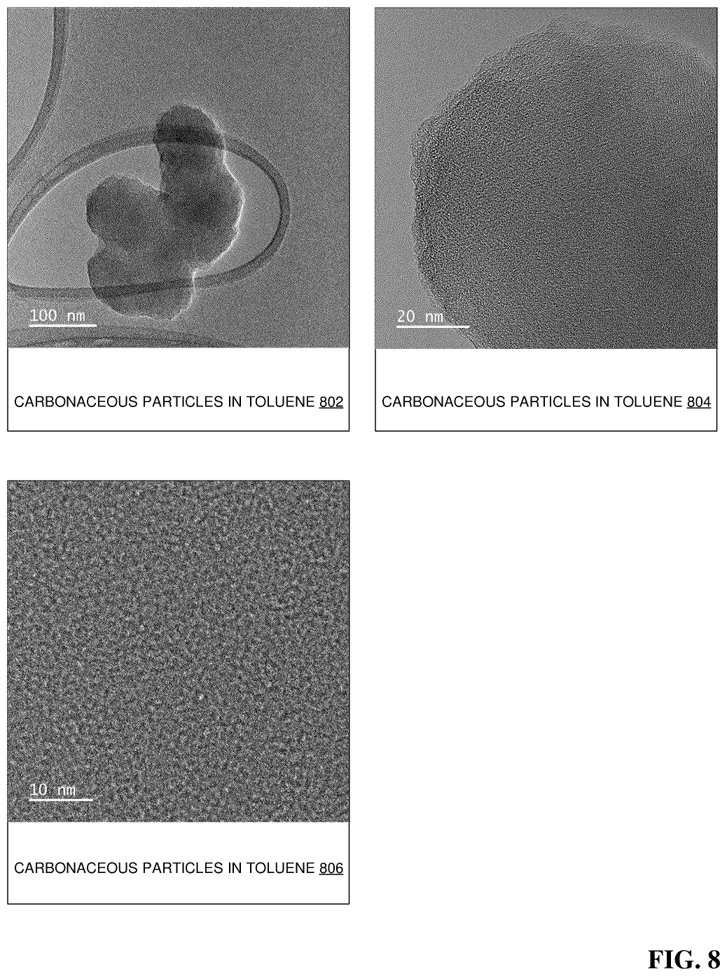

FIG. 8 depicts transmission electron microscopy images of carbonaceous particles in toluene, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 802 shows a carbonaceous particle at a larger scale of magnification of 100 nm. The carbonaceous particle of the image 802 may have an irregular, multi-lobed structure with a size of approximately 100 nm as indicated by the scale bar. The particle may exhibit a darker contrast against the lighter background, which may suggest a higher density or thickness. Additionally, image 804 presents a higher magnification view of a carbonaceous particle at a scale magnification of 20 nm. Image 806 shows the highest magnification view of carbonaceous particles at a scale of magnification of 10 nm.

As shown, the morphology of the carbonaceous particles may vary from larger, irregular structures to smaller, more uniform particles. This variation in size and shape may be influenced by factors such as synthesis conditions, processing methods, or interactions with the toluene solvent.

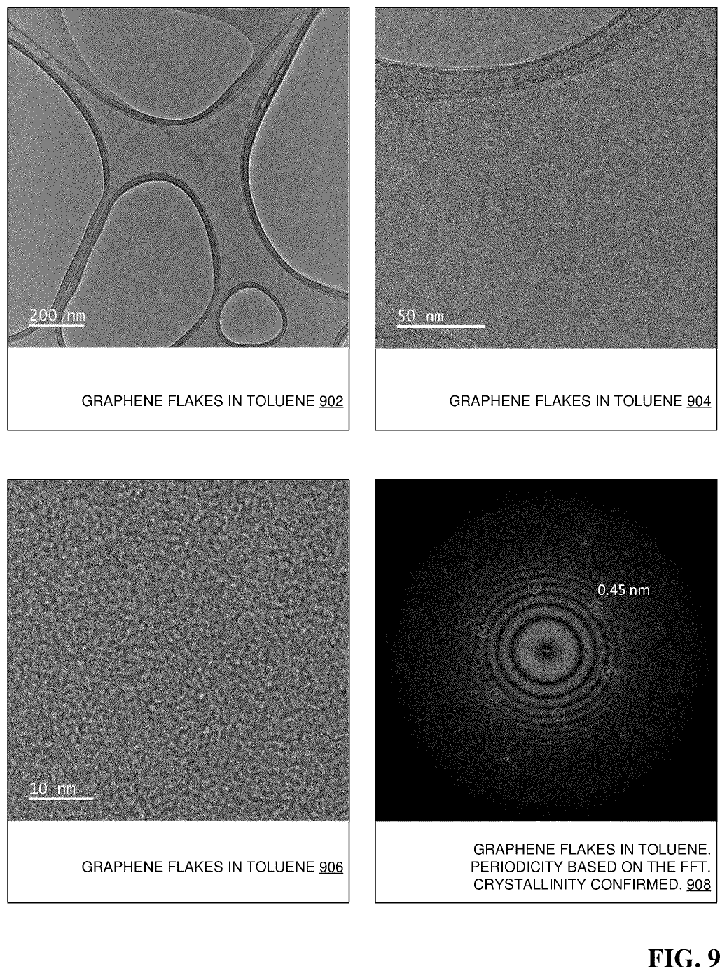

FIG. 9 shows transmission electron microscopy images and a Fast Fourier Transform pattern of graphene flakes in toluene, according to aspects of the present disclosure. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 902 shows graphene flakes at 50 k× magnification. In some cases, this image 902 may reveal several large, irregularly shaped particles with smooth edges, which may suggest graphene-like structures. The carbonaceous particle may exhibit a layered appearance, potentially indicating multiple graphene sheets stacked or folded upon each other.

Image 904 displays graphene flakes at a higher magnification, at 250 k× magnification. Image 906 displays graphene flakes at an even higher magnification, at 1 M× magnification. This image may reveal a dense distribution of small, granular structures, which may indicate the presence of nanoparticles. Further, the image 906 shows carbonaceous particles in smaller particulate forms.

Image 908 shows FFT pattern, which may be derived from the graphene flakes in toluene. The image 908 shows an FFT pattern derived from the close-up view of the graphene flakes. The FFT pattern may reveal a 6-fold symmetry, as indicated by the circular marker at 0.45 nm matching the in-plane spacing for graphene. This 6-fold symmetry may be characteristic of the hexagonal lattice structure of graphene.

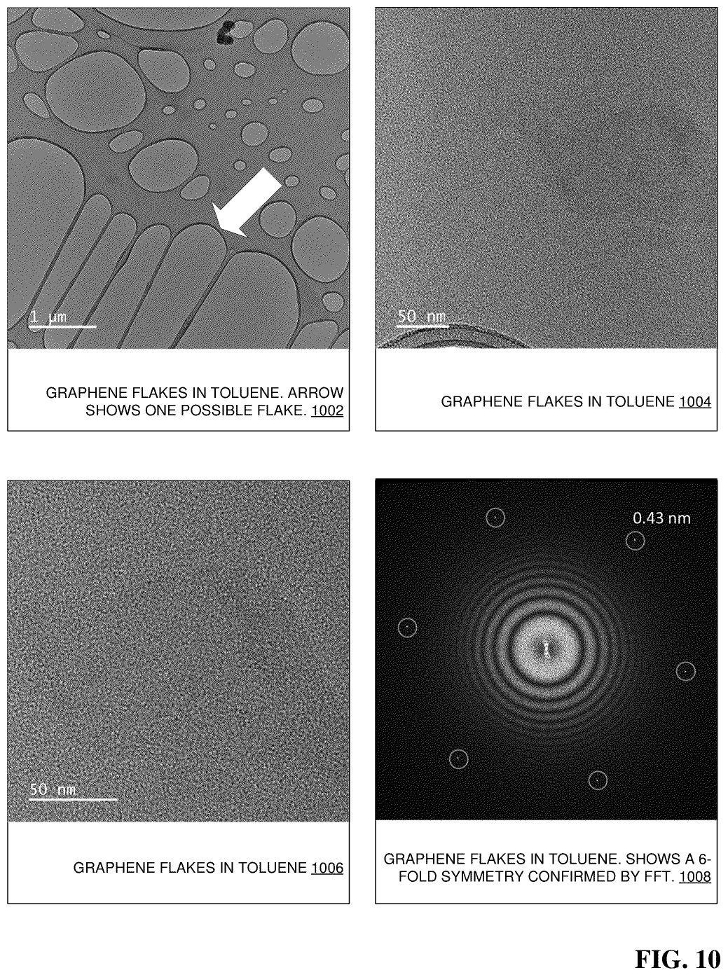

FIG. 10 illustrates transmission electron microscopy images and a Fast Fourier Transform pattern of graphene flakes in toluene, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1002 shows graphene flakes dispersed in toluene at 10 k× magnification. The graphene flakes of the image 1002 may appear as dark shapes against a lighter background and may exhibit a range of sizes and morphologies, including circular and elongated forms.

Image 1004 shows graphene flakes at 250 k× magnification. Image 1006 displays graphene flakes at 250 k× magnification.

Image 1008 shows an FFT pattern derived from the graphene flakes in toluene. The FFT pattern may reveal a 6-fold symmetry, as indicated by the circular marker at 0.43 nm matching the in-plane spacing for graphene. This 6-fold symmetry may be characteristic of the hexagonal lattice structure of graphene.

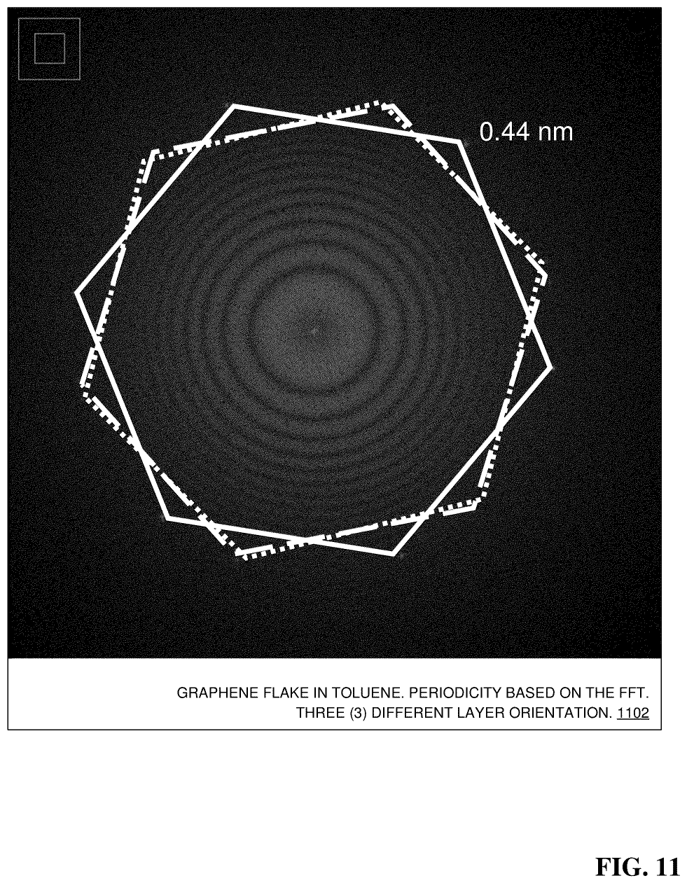

FIG. 11 depicts a Fast Fourier Transform pattern of carbonaceous particles in toluene, according to aspects of the present disclosure. As an option, the pattern may be implemented in the context of any one or more of the embodiments set forth in any previous and/or subsequent figure(s) and/or description thereof. Of course, however, the pattern may be implemented in the context of any desired environment. Further, the aforementioned definitions may equally apply to the description below.

As shown, a Fast Fourier Transform (FFT) pattern of graphene flakes in toluene is illustrated as image 1102. In some aspects, the FFT pattern of the image 1102 may exhibit a hexagonal symmetry, indicated by six distinct bright spots arranged in a hexagonal shape around the central bright spot. This hexagonal arrangement may suggest a crystalline structure with six-fold symmetry, which may be characteristic of graphene-like materials.

In some implementations, the FFT pattern of the image 1102 may reveal the presence of three different layer orientations (shown in solid line, dotted line, and dashed line). This may be evidenced by a slight rotational offset of the hexagonal patterns, resulting in a more complex overall symmetry. The presence of multiple orientations may suggest that the carbonaceous particles comprise stacked and/or folded graphene-like sheets with varying alignments.

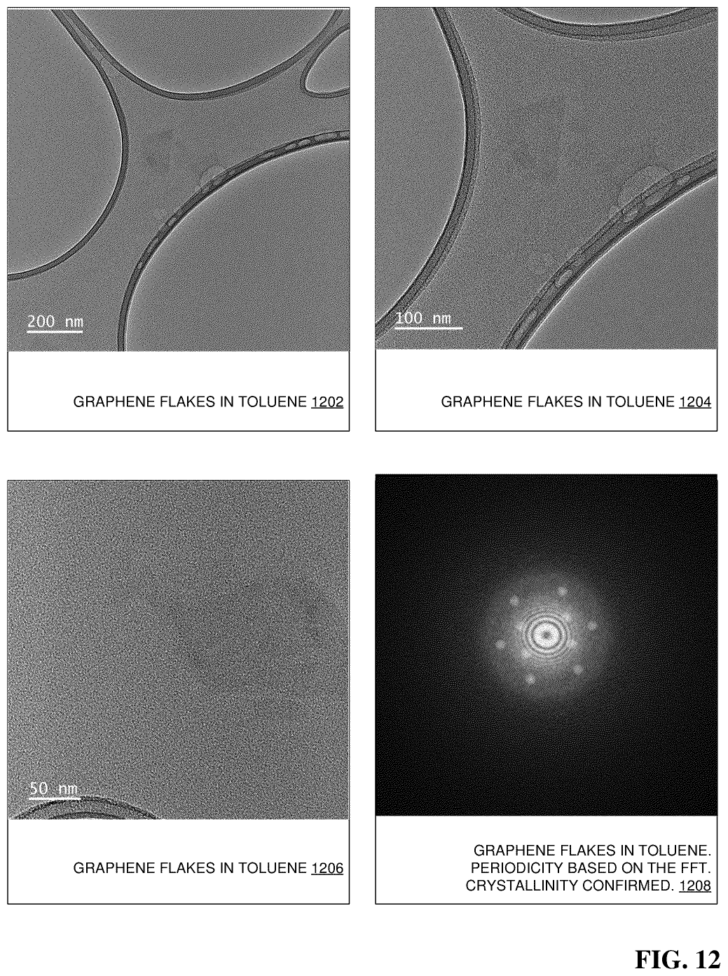

FIG. 12 shows transmission electron microscopy images and a Fast Fourier Transform pattern of carbonaceous particles in toluene, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1202 shows graphene flakes 1202 in toluene at 50 k× magnification. The graphene flakes 1202 may appear as large, curved structures with distinct edges and varying sizes. These curved structures may suggest the presence of graphene-like sheets or other layered carbon materials.

Graphene flakes in image 1204 may present a higher magnification TEM image of the particles in toluene, at magnification 100 k×. This image may provide a closer view of the particle structure, potentially revealing more detail of the curved edges and surface features.

Image 1206 shows graphene flakes at 150 k× magnification. This image may show the fine structure of the particles, including their layered nature and the interaction with the toluene solvent. In some cases, the carbonaceous particles of the 1206 may reveal the presence of both single-layer and multi-layer regions within the curved structures.

As shown, a Fast Fourier Transform (FFT) pattern of graphene flakes in toluene is illustrated as image 1208. In some aspects, the FFT pattern of the image 1208 may exhibit a hexagonal symmetry, indicated by six distinct bright spots arranged in a hexagonal shape around the central bright spot. This hexagonal arrangement may suggest a crystalline structure with six-fold symmetry, which may be characteristic of graphene-like materials.

In some implementations, the FFT pattern of the image 1208 may reveal the presence of three different layer orientations (shown in solid line, dotted line, and dashed line). This may be evidenced by a slight rotational offset of the hexagonal patterns, resulting in a more complex overall symmetry. The presence of multiple orientations may suggest that the carbonaceous particles comprise stacked and/or folded graphene-like sheets with varying alignments.

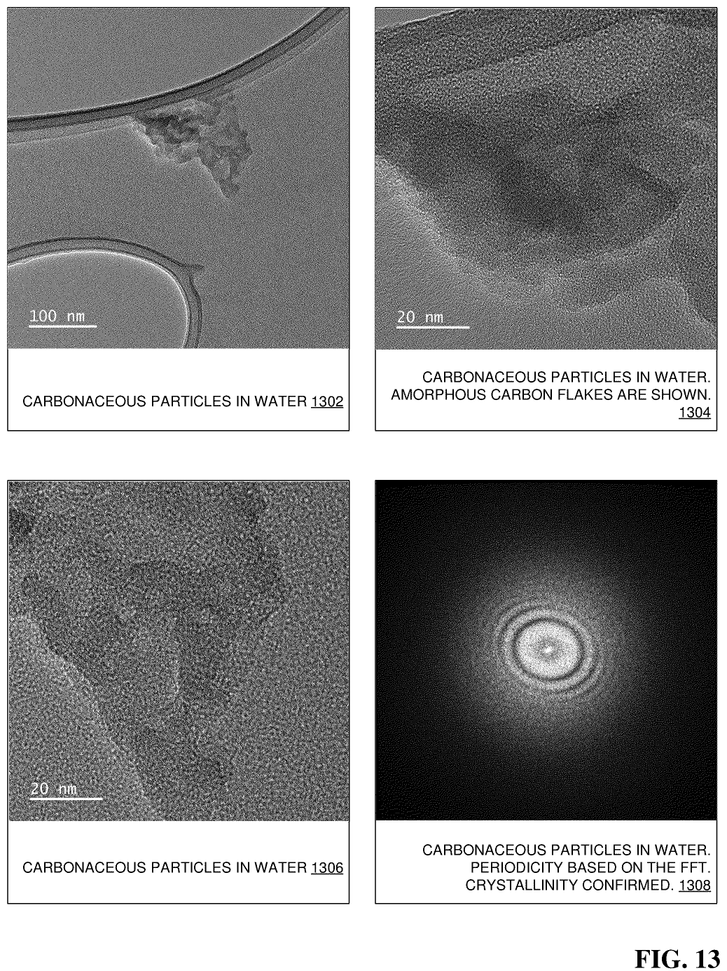

FIG. 13 illustrates transmission electron microscopy images of carbonaceous particles in water, according to aspects of the present disclosure. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1302 shows carbonaceous particles in water at 100 k× magnification. The carbonaceous particles of the image 1302 may appear as a cluster of dark, irregularly shaped structures against a lighter background. Image 1304 shows carbonaceous particles in water, and in particular, displays amorphous carbon flakes in water at 500 k× magnification. The carbonaceous particles of the image 1304 may exhibit a flake-like structure with irregular edges and varying degrees of overlap. In some cases, the flake-like morphology may be indicative of exfoliated or layered carbon structures dispersed in the aqueous medium.

Image 1306 includes another view of carbonaceous particles in water at 500 k× magnification. The carbonaceous particles of the image 1306 in this view may appear as a collection of small, dark structures dispersed throughout the field of view.

Image 1308 shows the FFT pattern of the 1306 image. The lack of bright spots indicate the amorphous nature of the material.

In various embodiments, the use of water as a dispersion medium for the carbonaceous particles may affect their distribution and stability. In some cases, the hydrophilic or hydrophobic nature of the particle surfaces may influence their aggregation behavior and overall dispersion in the aqueous environment.

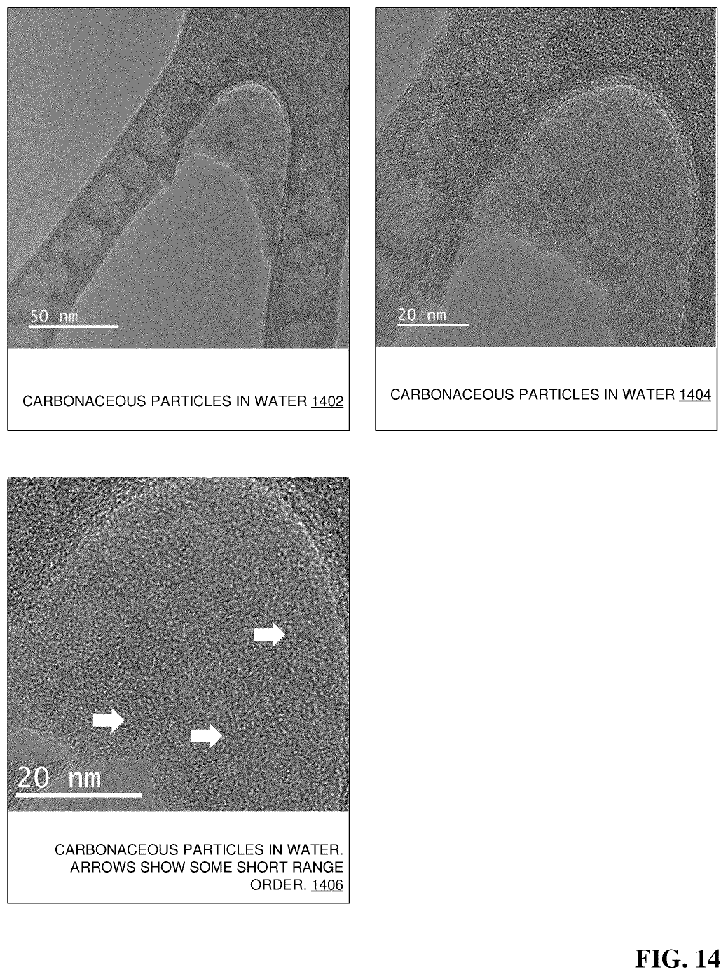

FIG. 14 depicts transmission electron microscopy images of carbonaceous particles in water, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1402 shows carbonaceous particles dispersed in water at a scale of 50 nm. The carbonaceous particles of the image 1402 may appear as darker regions against a lighter background, with some particles potentially showing layered or sheet-like structures. Image 1404 shows carbonaceous particles in water at 500 k× magnification. The carbonaceous particles of the image 1404 may exhibit similar characteristics to those in the image 1402, but with more visible detail of their morphology and internal structures. Further, image 1406 shows carbonaceous particles in water at 500 k× magnification. White arrows in the image may point to specific areas within the carbonaceous particles of the image 1406, indicating regions of short-range order. These areas may suggest localized structural organization within the particles. In some cases, the presence of short-range order may indicate partial crystallinity or the formation of small domains with regular atomic arrangements within the otherwise amorphous structure of the carbonaceous particles.

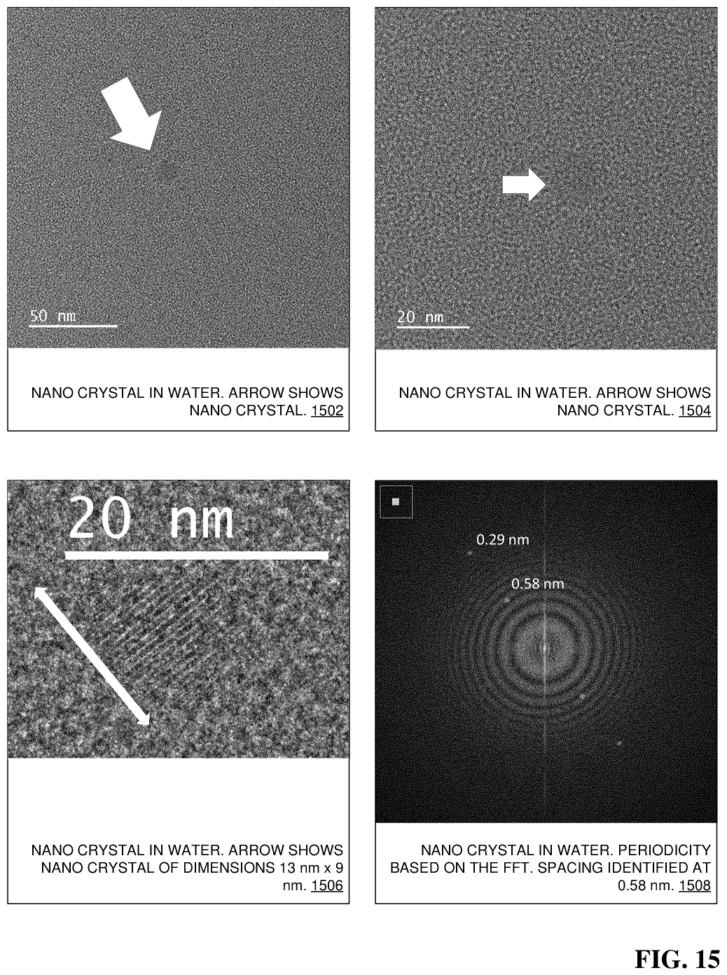

FIG. 15 shows transmission electron microscopy images and a Fast Fourier Transform pattern of a nano crystal in water, according to aspects of the present disclosure. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1502 shows a nano crystal in water at 250 k× magnification. An arrow within the image 1502 shows a nano crystal within the sample. The nano crystal of the image 1502 may appear as dark structures against a lighter background, with some particles exhibiting crystalline features.

Image 1504 shows a nano crystal at the higher magnification of 500 k×. In some cases, the arrow of the image 1504 indicates a nano crystal structure within the sample.

Image 1506 shows a nano crystal, specifically highlighting a nano crystal with roughly dimensions of 13 nm×9 nm. This panel may provide a closer view of the crystalline. The nano crystal may exhibit a regular lattice structure.

Additionally, an FFT pattern 1508 is shown which is derived from the nano crystal in water. The FFT pattern 1508 may display spots, which may indicate periodicity in the structure of the particles. In some aspects, the spacing identified in the FFT pattern 1508 may be 0.29 nm, which may provide information about the atomic arrangement within the nano crystal.

In one embodiment, the presence of nano crystalline structures within the carbonaceous particles may suggest localized regions of ordered carbon atoms. In some cases, these nano crystals may influence the overall properties of the carbonaceous material, such as its electrical conductivity or optical characteristics.

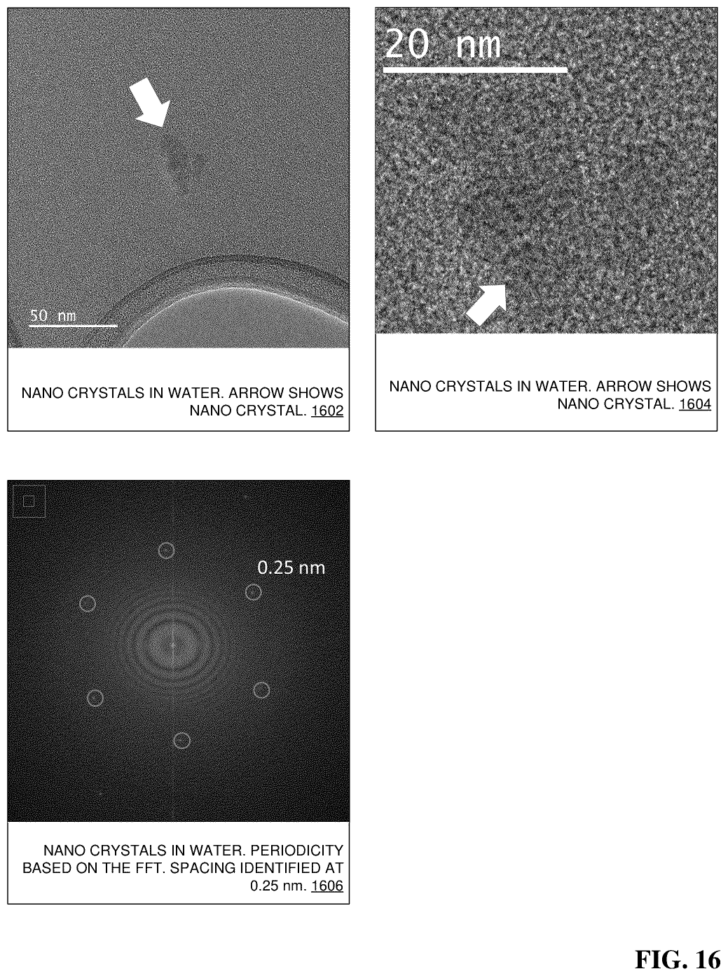

FIG. 16 illustrates transmission electron microscopy images and a Fast Fourier Transform pattern of nano crystals in water, according to an embodiment. As an option, the images may be implemented in the context of any one or more of the embodiments set forth in any previous and/or subsequent figure(s) and/or description thereof. Of course, however, the images may be implemented in the context of any desired environment. Further, the aforementioned definitions may equally apply to the description below.

As shown, image 1602 shows nano crystals in water at 250 k× magnification. An arrow within the image 1602 shows a nano crystal structure within the sample. The nano crystals of the image 1602 may appear as dark regions against a lighter background, with some particles exhibiting crystalline features. The presence of nano crystalline structures within the nano crystals of the image 1602 may suggest localized regions of ordered carbon atoms.

Image 1604 displays nano crystals in water at a higher magnification, at 500 k× magnification. In some implementations, an arrow in the image 1604 shows a nano crystal structure similar to that seen in the image 1602.

Additionally, an FFT pattern 1606 is displayed which is derived from the nano crystals in water. The FFT pattern may reveal a 6-fold symmetry, as indicated by the circular marker at 0.25 nm matching the in-plane spacing for graphene. This 6-fold symmetry may be characteristic of the hexagonal lattice structure of graphene.

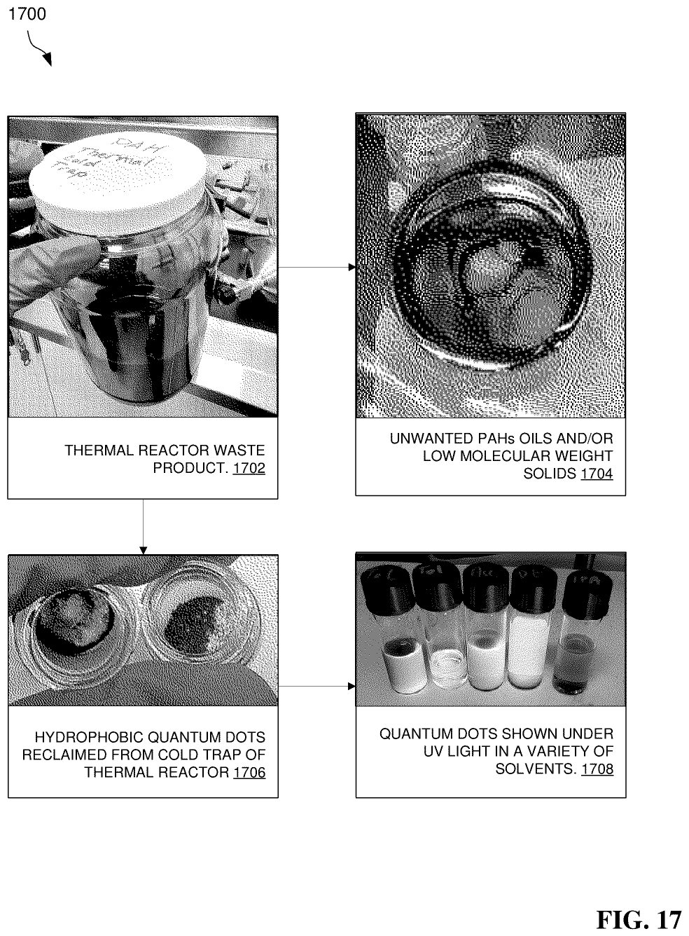

FIG. 17 depicts a process flow 1700 for reclaiming quantum dots from thermal reactor waste products, according to aspects of the present disclosure. As an option, the process flow 1700 may be implemented in the context of any one or more of the embodiments set forth in any previous and/or subsequent figure(s) and/or description thereof. Of course, however, the process flow 1700 may be implemented in the context of any desired environment. Further, the aforementioned definitions may equally apply to the description below.

As shown, the process flow 1700 may begin with a thermal reactor waste product 1702, which may be contained in a large jar or vessel. The thermal reactor waste product 1702 may comprise various carbonaceous materials, including potential quantum dot precursors.

The process flow 1700 may proceed to separate unwanted components from the thermal reactor waste product, per step 1702. In some implementations, this separation step 1702 may result in unwanted PAHs oils and/or low molecular weight solids, shown in step 1704. These unwanted components per step 1704 may be collected in a separate container for disposal or further processing.

Additionally, the process flow 1700 may yield hydrophobic quantum dots, per step 1706. In some cases, these hydrophobic quantum dots of step 1706 may be reclaimed from the cold trap of the thermal reactor. The hydrophobic nature of the quantum dots of step 1706 may be influenced by the synthesis conditions and the characteristics of the thermal reactor waste product of step 1702.

The process flow 1700 may further involve dispersing the reclaimed hydrophobic quantum dots of step 1706 in a variety of solvents. This step may result in quantum dots in solvents, per step 1708, which may be contained in multiple vials or containers. In some implementations, the quantum dots in solvents of step 1708 may exhibit different properties under UV light, depending on the specific solvent used for dispersion.

The reclamation process illustrated in the process flow 1700 may offer advantages in terms of resource utilization and waste reduction. By extracting valuable quantum dots from thermal reactor waste products, the method may provide a means of recovering potentially useful materials that might otherwise be discarded.

In some aspects, the hydrophobic nature of the reclaimed quantum dots of step 1706 may influence their solubility and dispersion characteristics in various solvents. This property may be leveraged for specific applications or further processing steps, such as surface functionalization or integration into hydrophobic matrices.

The ability to disperse the reclaimed hydrophobic quantum dots of step 1706 in different solvents, as shown by the quantum dots in solvents of step 1708, may allow for tuning of the quantum dot properties. For example, various solvents may be used to enable isolation of specific size range and surface properties of quantum dots, which may be based, at least in part, on interactions of a particular solvent property and the surface/size property of quantum dots. In some cases, the choice of solvent may affect the optical, electronic, or chemical characteristics of the quantum dots, potentially enabling a range of applications in fields such as optoelectronics, sensing, or biomedical imaging.

In various embodiments, the process flow 1700 may be adaptable to various types of thermal reactor waste products and may be scaled according to the volume of waste material available. In some implementations, the specific steps and conditions of the reclamation process may be optimized based on the composition of the thermal reactor waste product of step 1702 and the desired properties of the reclaimed quantum dots.

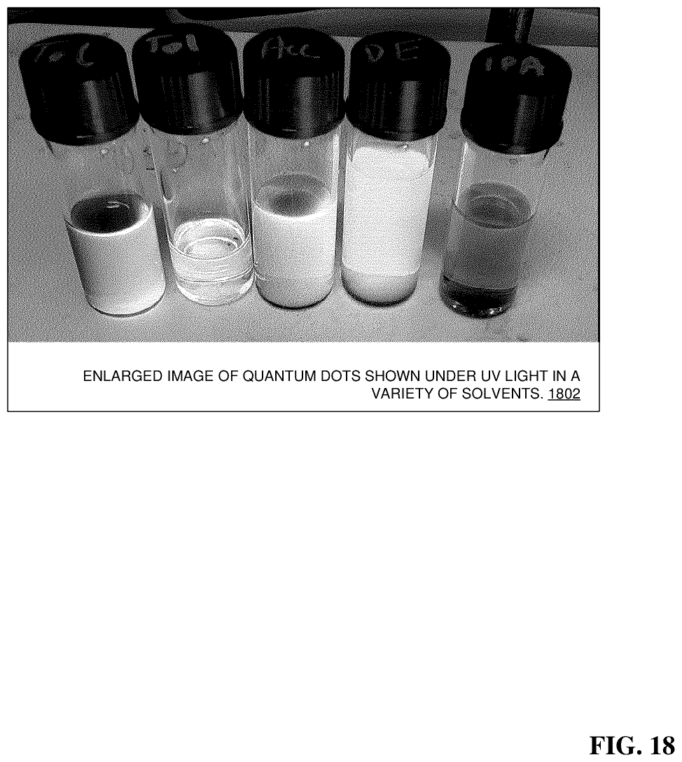

FIG. 18 shows quantum dot samples under UV light in various solvents, according to an embodiment. As an option, the samples may be implemented in the context of any one or more of the embodiments set forth in any previous and/or subsequent figure(s) and/or description thereof. Of course, however, the samples may be implemented in the context of any desired environment. Further, the aforementioned definitions may equally apply to the description below.

As shown, five samples (all of which are in a variety of solvents in varying proportions) exhibit fluorescence. In various embodiments, the production of graphene quantum dots may be dependent on the manner of producing the graphene. For example, the production of graphene may be outputted (or otherwise generated) from a reactor (including plasma reactor).

The quantum dot samples 1802 may exhibit diverse optical properties, as evidenced by their distinct appearances under UV illumination. These variations in appearance among the quantum dot samples 1802 may demonstrate the effect of different solvents on the optical properties of the quantum dots. In some implementations, the diverse visual characteristics may suggest potential differences in fluorescence, dispersion, or other photophysical properties of the quantum dots in various solvent environments.

The quantum dots may exhibit fluorescence when dispersed in different solvents, as evidenced by the glowing appearance of the solutions under UV illumination. In some aspects, the intensity and color of the fluorescence may vary depending on the specific solvent used for dispersion. This variation in fluorescence properties may be attributed to factors such as the interaction between the quantum dots and the solvent molecules, the degree of aggregation or dispersion of the quantum dots, and/or the influence of the solvent on the electronic structure of the quantum dots.

The image of the quantum dot samples 1802 may provide a visual representation of how the choice of solvent can influence the behavior and properties of quantum dots. In some cases, this solvent-dependent behavior may be relevant for applications (but not limited solely to) in areas such as sensing, imaging, and/or optoelectronics. In one embodiment, the ability to tune the optical properties of quantum dots through solvent selection may offer opportunities for tailoring their characteristics to specific application requirements.

In some implementations, the quantum dot samples 1802 may be derived from carbonaceous materials, such as those obtained through the reclamation process described in relation to FIG. 1 and/or FIG. 17. The diverse optical properties observed in different solvents may reflect the complex nature of these carbonaceous quantum dots and their sensitivity to their local environment.

The fluorescence exhibited by the quantum dot samples 1802 may be a result of quantum confinement effects, where the small size of the particles leads to discrete energy levels and enhanced radiative recombination of excited charge carriers. In some aspects, the specific fluorescence characteristics observed in each solvent may provide insights into the size distribution, surface chemistry, or electronic structure of the quantum dots.

Additionally, the carbon/graphene outputted and/or produced from reactors may include poly aromatic hydrocarbons. The filtrate discussed hereinabove may include such poly aromatic hydrocarbons. In various embodiments, the graphene quantum dots produced may include a variety of sizes. Additionally, carbon particles may be extracted from a bigger carbon particle, or may be constructed by combining together smaller carbon particles. Still yet, the structure and morphology of the resulting graphene quantum dots may differ (from conventional quantum dots) based on the carbon outputted and/or produced from a reactor.

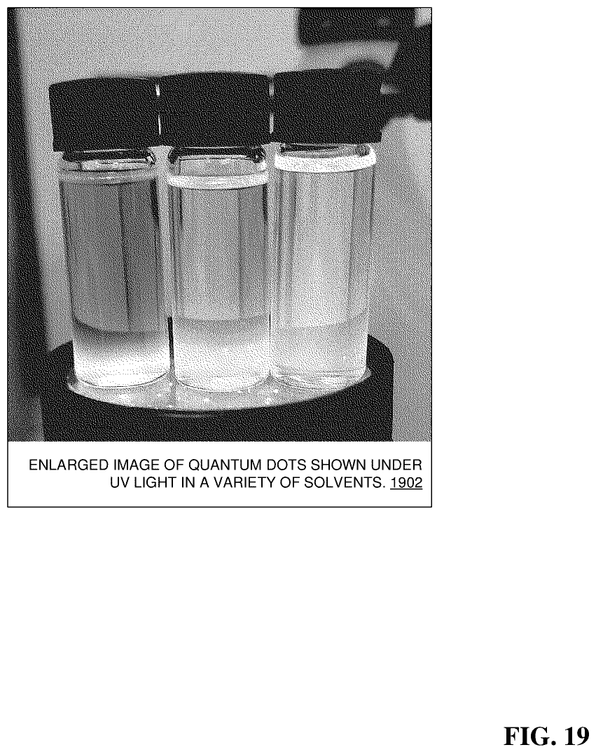

FIG. 19 illustrates quantum dot samples under UV light in toluene, according to aspects of the present disclosure. As an option, the samples may be implemented in the context of any one or more of the embodiments set forth in any previous and/or subsequent figure(s) and/or description thereof. Of course, however, the samples may be implemented in the context of any desired environment. Further, the aforementioned definitions may equally apply to the description below.

As shown, three samples are shown exhibiting fluorescence of quantum dots. It is to be appreciated that the mixture of the quantum dots is shown in various concentrations of toluene, although it is envisioned that other fluorescent activity (in varying concentrations) may be exhibited equally for isopropyl alcohol, water, etc. Additionally, the discussion relating to FIG. 18 applies equally to FIG. 19, which provides another example and image of fluorescence of quantum dots.

In various embodiments, variations in fluorescence intensity and color among the quantum dot samples may reflect the influence of different solvents on the optical properties of the quantum dots. In some aspects, these differences may arise from factors such as the interaction between the quantum dots and the solvent molecules, the degree of aggregation or dispersion of the quantum dots, and/or the effect of the solvent on the electronic structure of the quantum dots.

The ability to observe distinct fluorescence characteristics in different solvents may be relevant for various applications of quantum dots. In some cases, this solvent-dependent behavior may be leveraged for sensing applications, where changes in the local environment could be detected through shifts in fluorescence properties. Additionally, the tunable optical properties demonstrated by the quantum dot samples may be useful, for example, for imaging applications or the development of optoelectronic devices.

In some implementations, the quantum dot samples may be derived from carbonaceous materials, such as those obtained through reclamation processes from thermal reactor waste products. The diverse optical properties observed in different solvents may reflect the complex nature of these carbonaceous quantum dots and their sensitivity to their local environment.

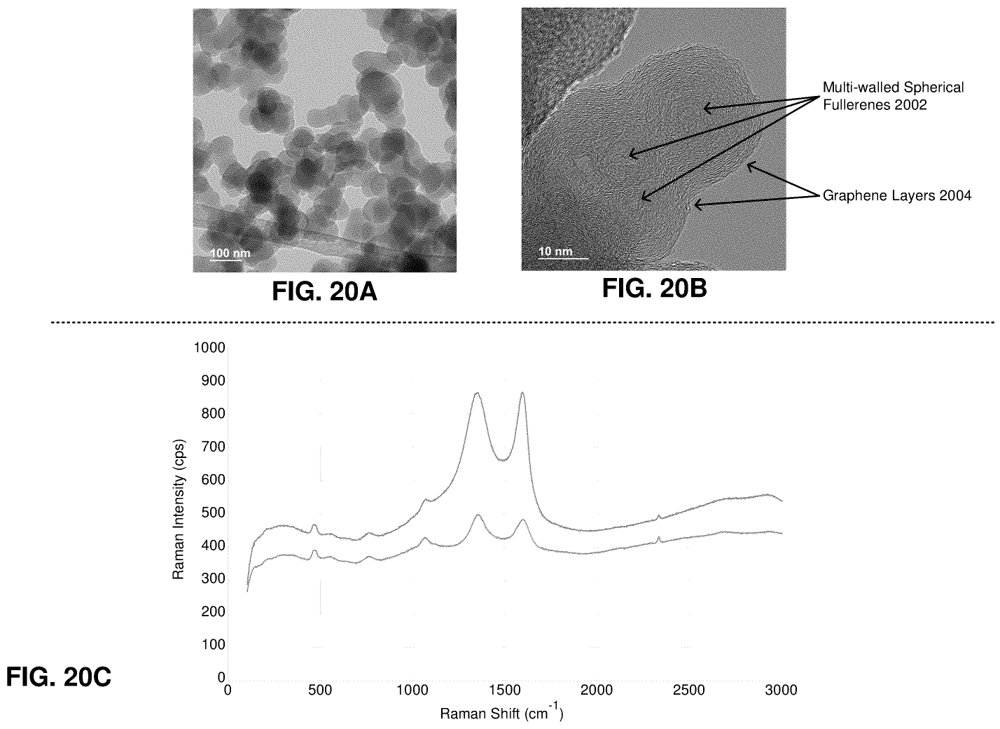

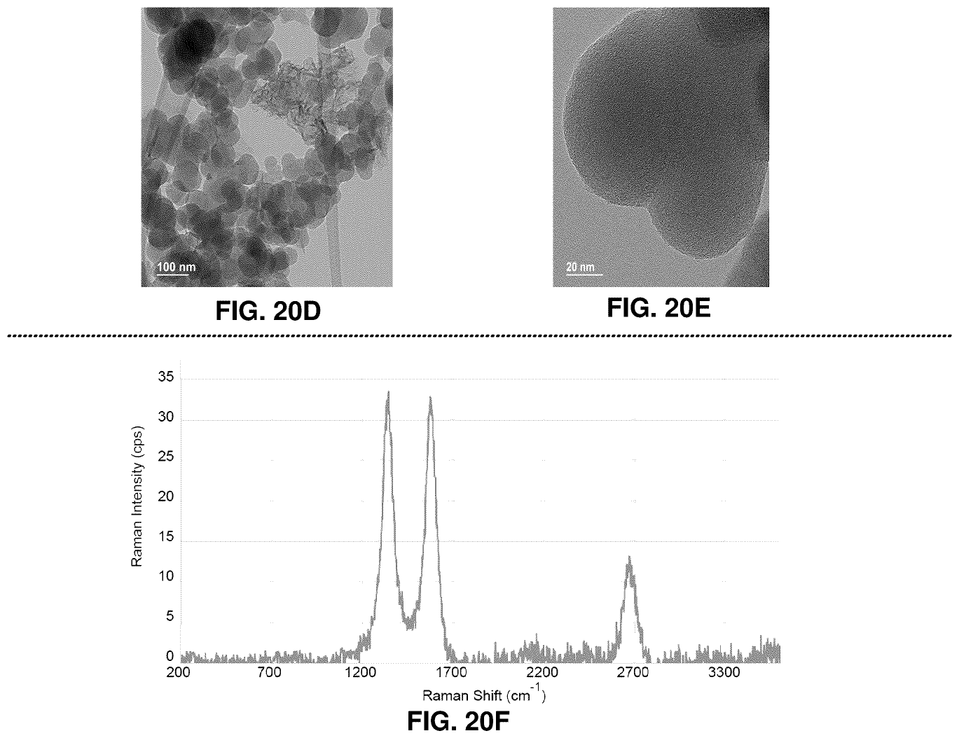

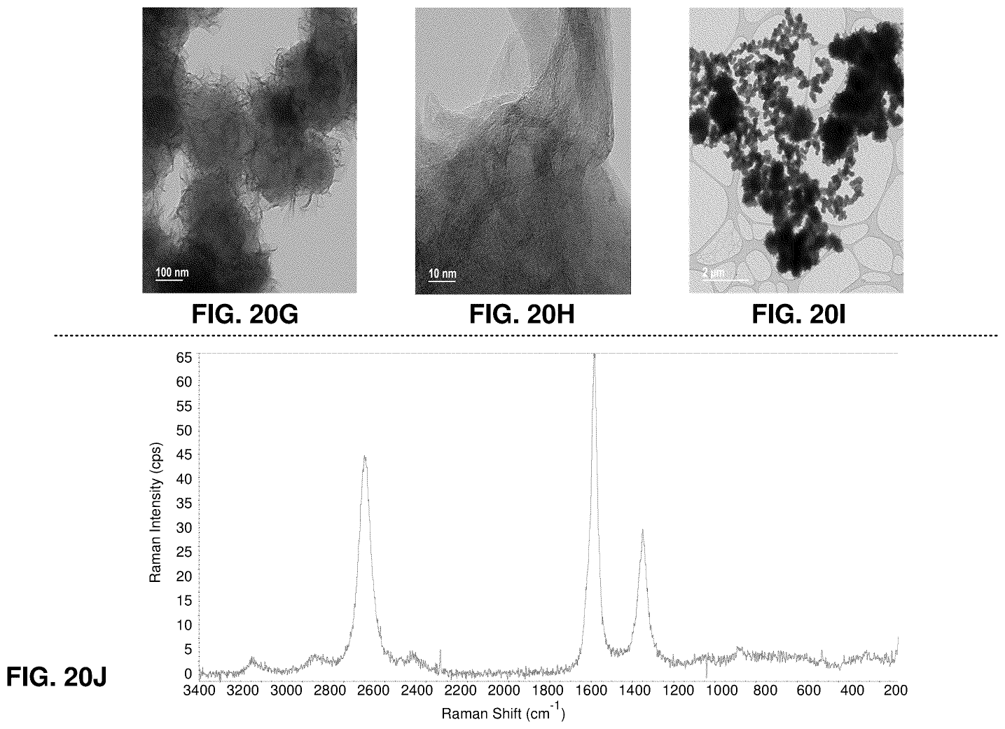

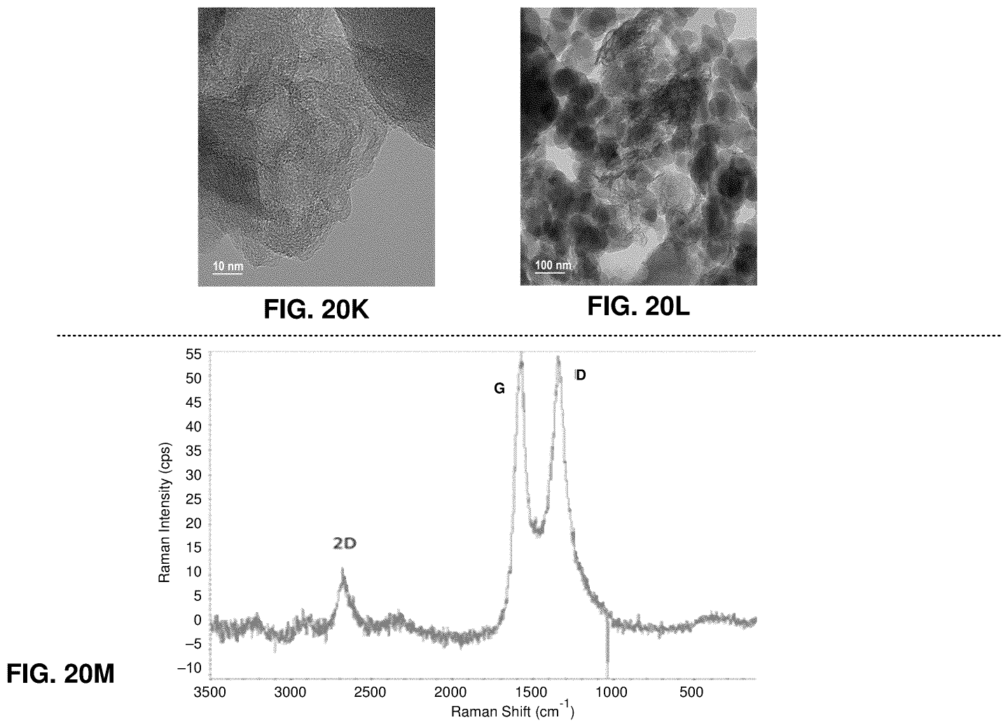

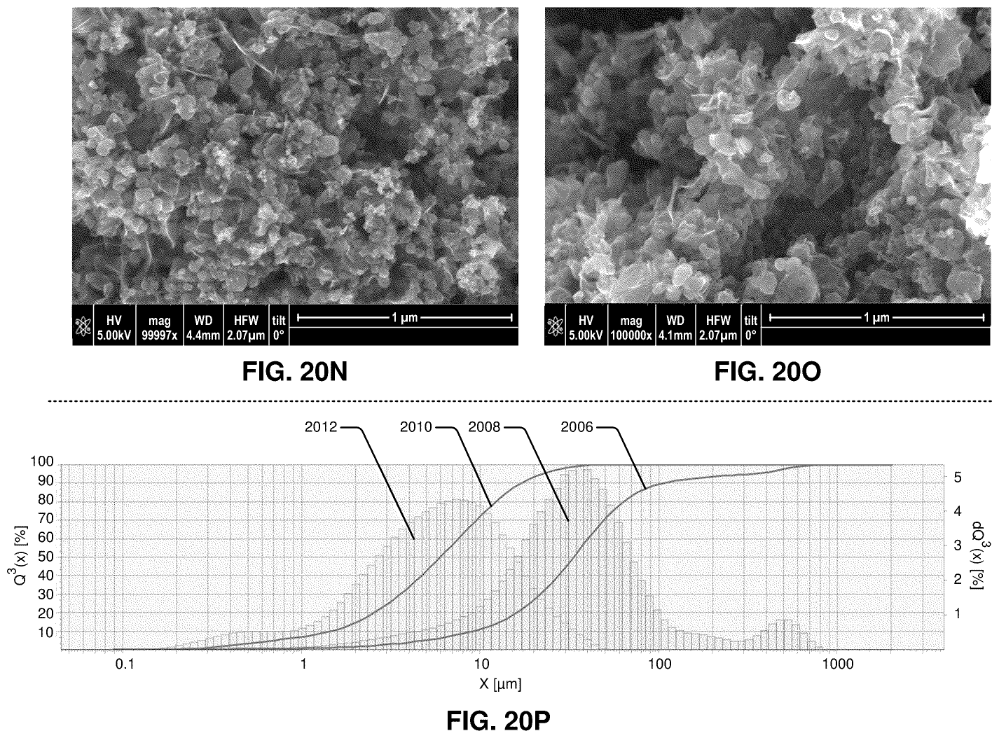

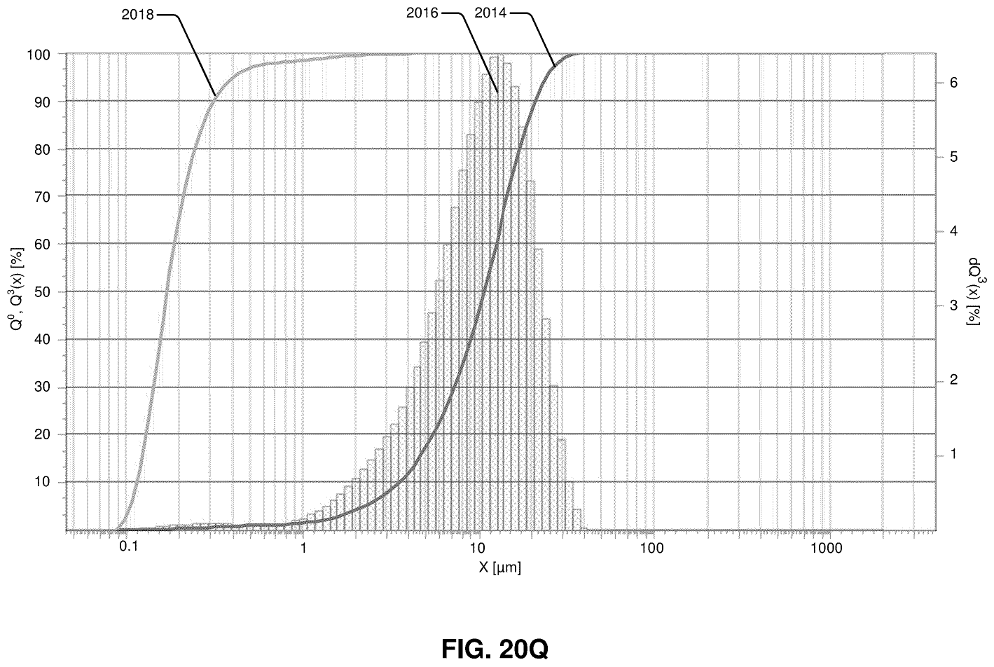

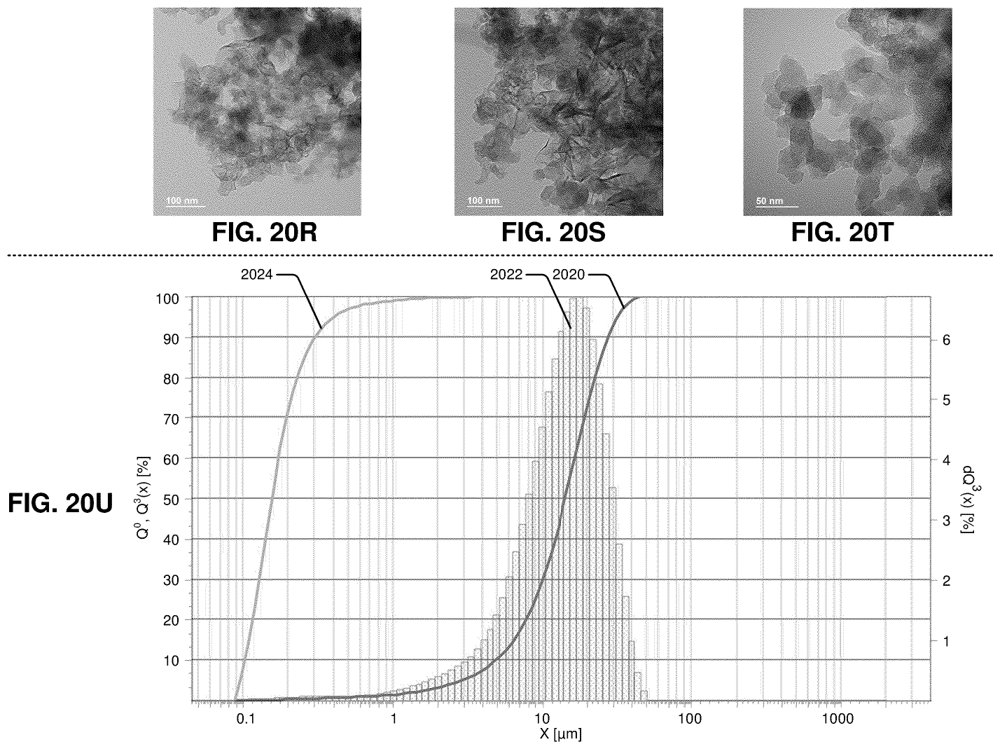

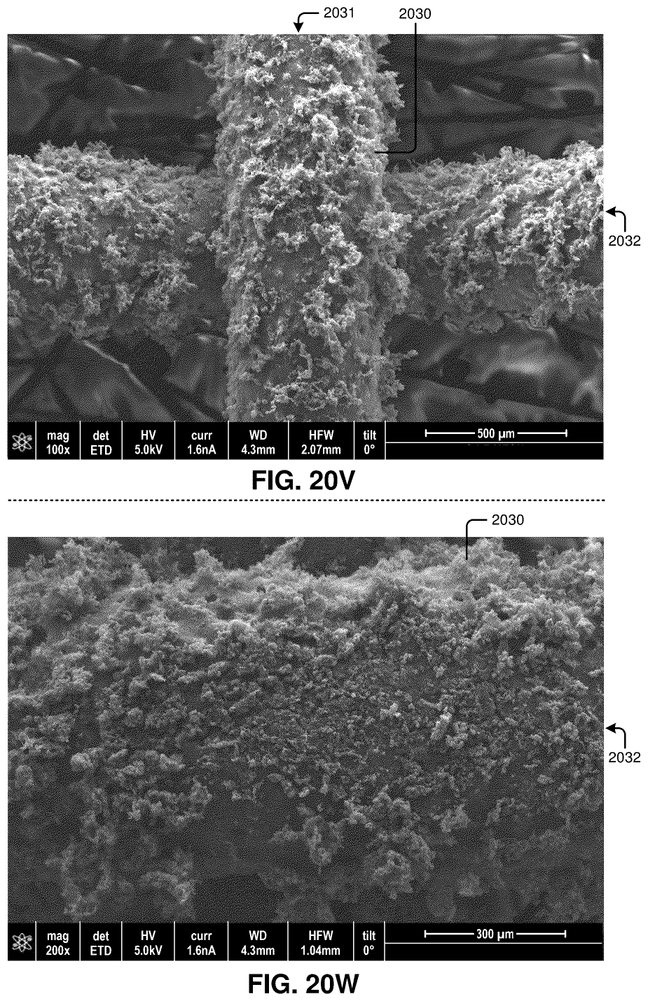

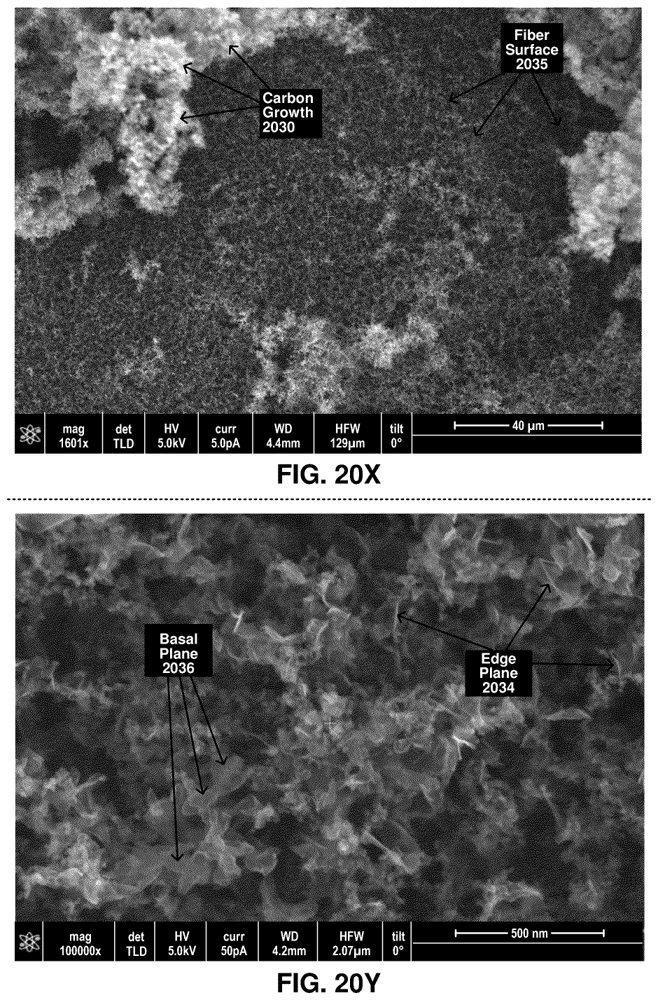

FIG. 20A through FIG. 20Y depict structured carbons, various carbon nanoparticles, various carbon-containing aggregates, and various three-dimensional carbon-containing structures that are grown over other materials, according to some embodiments of the present disclosure.

In some embodiments, the carbon nanoparticles and aggregates are characterized by a high “uniformity” (i.e., high mass fraction of desired carbon allotropes), a high degree of “order” (i.e., low concentration of defects), and/or a high degree of “purity” (i.e., low concentration of elemental impurities), in contrast to the lower uniformity, less ordered, and lower purity particles achievable with conventional systems and methods.

In some embodiments, the nanoparticles produced using the methods described herein contain multi-walled spherical fullerenes (MWSFs) or connected MWSFs and have a high uniformity (e.g., a ratio of graphene to MWSF from 20% to 80%), a high degree of order (e.g., a Raman signature with an I_{D}/I_{G} ratio from 0.95 to 1.05), and a high degree of purity (e.g., the ratio of carbon to other elements (other than hydrogen) is greater than 99.9%). In some embodiments, the nanoparticles produced using the methods described herein contain MWSFs or connected MWSFs, and the MWSFs do not contain a core composed of impurity elements other than carbon. In some cases, the particles produced using the methods described herein are aggregates containing the nanoparticles described above with large diameters (e.g., greater than 10 μm across).

Conventional methods have been used to produce particles containing multi-walled spherical fullerenes with a high degree of order, but the conventional methods lead to carbon products with a variety of shortcomings. For example, high temperature synthesis techniques lead to particles with a mixture of many carbon allotropes and therefore low uniformity (e.g., less than 20% fullerenes to other carbon allotropes) and/or small particle sizes (e.g., less than 1 μm, or less than 100 nm in some cases). Methods using catalysts lead to products including the catalyst elements and therefore have low purity (e.g., less than 95% carbon to other elements) as well. These undesirable properties also often lead to undesirable electrical properties of the resulting carbon particles (e.g., electrical conductivity of less than 1000 S/m).

In some embodiments, the carbon nanoparticles and aggregates described herein are characterized by Raman spectroscopy that is indicative of the high degree of order and uniformity of structure. In some embodiments, the uniform, ordered and/or pure carbon nanoparticles and aggregates described herein are produced using relatively high speed, low cost improved thermal reactors and methods, as described below. Additional advantages and/or improvements will also become apparent from the following disclosure.

In the present disclosure, the term “graphene” refers to an allotrope of carbon in the form of a two-dimensional, atomic-scale, hexagonal lattice in which one atom forms each vertex. The carbon atoms in graphene are sp²-bonded. Additionally, graphene has a Raman spectrum with two main peaks: a G-mode at approximately 1580 cm⁻and a D-mode at approximately 1350 cm⁻¹ (when using a 532 nm excitation laser).

In the present disclosure, the term “fullerene” refers to a molecule of carbon in the form of a hollow sphere, ellipsoid, tube, or other shapes. Spherical fullerenes can also be referred to as Buckminsterfullerenes, or buckyballs. Cylindrical fullerenes can also be referred to as carbon nanotubes. Fullerenes are similar in structure to graphite, which is composed of stacked graphene sheets of linked hexagonal rings. Fullerenes may also contain pentagonal (or sometimes heptagonal) rings.

In the present disclosure, the term “multi-walled fullerene” refers to fullerenes with multiple concentric layers. For example, multi-walled nanotubes (MWNTs) contain multiple rolled layers (concentric tubes) of graphene. Multi-walled spherical fullerenes (MWSFs) contain multiple concentric spheres of fullerenes.

In the present disclosure, the term “nanoparticle” refers to a particle that measures from 1 nm to 989 nm. The nanoparticle can include one or more structural characteristics (e.g., crystal structure, defect concentration, etc.), and one or more types of atoms. The nanoparticle can be any shape, including but not limited to spherical shapes, spheroidal shapes, dumbbell shapes, cylindrical shapes, elongated cylindrical type shapes, rectangular prism shapes, disk shapes, wire shapes, irregular shapes, dense shapes (i.e., with few voids), porous shapes (i.e., with many voids), etc.

In the present disclosure, the term “aggregate” refers to a plurality of nanoparticles that are connected together by elechrostatic forces (e.g., Van der Waals forces, London dispersion forces, dipole-dipole interactions, hydrogen bonding, etc.) by covalent bonds, by ionic bonds, by metallic bonds, or by other physical or chemical interactions. Aggregates can vary in size considerably, but in general are larger than about 500 nm.

In some embodiments, a carbon nanoparticle, as described herein, includes two or more connected multi-walled spherical fullerenes (MWSFs) and layers of graphene coating the connected MWSFs. In some embodiments, a carbon nanoparticle, as described herein, includes two or more connected multi-walled spherical fullerenes (MWSFs) and layers of graphene coating the connected MWSFs where the MWSFs do not contain a core composed of impurity elements other than carbon. In some embodiments, a carbon nanoparticle, as described herein, includes two or more connected multi-walled spherical fullerenes (MWSFs) and layers of graphene coating the connected MWSFs where the MWSFs do not contain a void (i.e., a space with no carbon atoms greater than approximately 0.5 nm, or greater than approximately 1 nm) at the center. In some embodiments, the connected MWSFs are formed of concentric, well-ordered spheres of sp²-hybridized carbon atoms, as contrasted with spheres of poorly-ordered, non-uniform, amorphous carbon particles.

In some embodiments, the nanoparticles containing the connected MWSFs have an average diameter in a range from 5 to 500 nm, or from 5 to 250 nm, or from 5 to 100 nm, or from 5 to 50 nm, or from 10 to 500 nm, or from 10 to 250 nm, or from 10 to 100 nm, or from 10 to 50 nm, or from 40 to 500 nm, or from 40 to 250 nm, or from 40 to 100 nm, or from 50 to 500 nm, or from 50 to 250 nm, or from 50 to 100 nm. Of course, nanoparticles containing connected MWSFs may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the carbon nanoparticles described herein form aggregates, wherein many nanoparticles aggregate together to form a larger unit. In some embodiments, a carbon aggregate includes a plurality of carbon nanoparticles. A diameter across the carbon aggregate is in a range from 10 to 500 μm, or from 50 to 500 μm, or from 100 to 500 μm, or from 250 to 500 μm, or from 10 to 250 μm, or from 10 to 100 μm, or from 10 to 50 μm. Of course, carbon aggregates may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the aggregate is formed from a plurality of carbon nanoparticles, as defined above. In some embodiments, aggregates contain connected MWSFs. In some embodiments, the aggregates contain connected MWSFs with a high uniformity metric (e.g., a ratio of graphene to MWSF from 20% to 80%), a high degree of order (e.g., a Raman signature with an I_{D}/I_{G} ratio from 0.95 to 1.05), and a high degree of purity (e.g., greater than 99.9% carbon).

One benefit of producing aggregates of carbon nanoparticles, particularly with diameters in the ranges described above, is that aggregates of particles greater than 10 μm are easier to collect than particles or aggregates of particles that are smaller than 500 nm. The ease of collection reduces the cost of manufacturing equipment used in the production of the carbon nanoparticles and increases the yield of the carbon nanoparticles. Additionally, particles greater than 10 μm in size pose fewer safety concerns compared to the risks of handling smaller nanoparticles, e.g., potential health and safety risks due to inhalation of the smaller nanoparticles. The lower health and safety risks, thus, further reduce the manufacturing cost.

In some embodiments, a carbon nanoparticle has a ratio of graphene to MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-MWSF ratio characterized by having any of the foregoing values or being within any of the foregoing exemplary ranges, or an average graphene-to-MWSF ratio characterized by having a value or being within a range between any of the foregoing exemplary ranges, without limitation and without departing from the scope of the presently described inventive concepts.

In some embodiments, a carbon nanoparticle has a ratio of graphene to connected MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to connected MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-connected MWSF ratio characterized by having any of the foregoing values or being within any of the foregoing exemplary ranges, or an average graphene-to-connected MWSF ratio characterized by having a value or being within a range between any of the foregoing exemplary ranges, without limitation and without departing from the scope of the presently described inventive concepts.

In some embodiments, Raman spectroscopy is used to characterize carbon allotropes to distinguish their molecular structures. For example, graphene can be characterized using Raman spectroscopy to determine information such as order/disorder, edge and grain boundaries, thickness, number of layers, doping, strain, and thermal conductivity. MWSFs have also been characterized using Raman spectroscopy to determine the degree of order of the MWSFs.

In some embodiments, Raman spectroscopy is used to characterize the structure of MWSFs or connected MWSFs. The main peaks in the Raman spectra are the G-mode and the D-mode. The G-mode is attributed to the vibration of carbon atoms in sp²-hybridized carbon networks, and the D-mode is related to the breathing of hexagonal carbon rings with defects. In some cases, defects may be present, yet may not be detectable in the Raman spectra. For example, if the presented crystalline structure is orthogonal with respect to the basal plane, the D-peak will show an increase. On the other hand, if presented with a perfectly planar surface that is parallel with respect to the basal plane, the D-peak will be zero.

When using 532 nm incident light, the Raman G-mode is typically at 1582 cm⁻¹ for planar graphite, however can be downshifted for MWSFs or connected MWSFs (e.g., down to 1565 cm⁻¹ or down to 1580 cm⁻¹). The D-mode is observed at approximately 1350 cm⁻¹ in the Raman spectra of MWSFs or connected MWSFs. The ratio of the intensities of the D-mode peak to G-mode peak (i.e., the I_{D}/I_{G}) is related to the degree of order of the MWSFs, where a lower I_{D}/I_{G} indicates a higher degree of order. An I_{D}/I_{G} near or below 1 indicates a relatively high degree of order, and an I_{D}/I_{G} greater than 1.1 indicates a lower degree of order.

In some embodiments, a carbon nanoparticle or a carbon aggregate containing MWSFs or connected MWSFs, as described herein, has a Raman spectrum with a first Raman peak at about 1350 cm⁻¹ and a second Raman peak at about 1580 cm⁻¹ when using 532 nm incident light. In some embodiments, the ratio of an intensity of the first Raman peak to an intensity of the second Raman peak (i.e., the I_{D}/I_{G}) for the nanoparticles or the aggregates described herein is in a range from 0.95 to 1.05, or from 0.9 to 1.1, or from 0.8 to 1.2, or from 0.9 to 1.2, or from 0.8 to 1.1, or from 0.5 to 1.5, or less than 1.5, or less than 1.2, or less than 1.1, or less than 1, or less than 0.95, or less than 0.9, or less than 0.8. Of course, carbon nanoparticles or aggregates including MWSFs or connected MWSFs may be characterized by a ratio of first and second Raman peak intensities having any of the foregoing values or being within any of the foregoing exemplary ranges, or a ratio of first and second Raman peak intensities characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high purity. In some embodiments, the carbon aggregate containing MWSFs or connected MWSFs has a ratio of carbon to metals of greater than 99.99%, or greater than 99.95%, or greater than 99.9%, or greater than 99.8%, or greater than 99.5%, or greater than 99%. In some embodiments, the carbon aggregate has a ratio of carbon to other elements of greater than 99.99%, or greater than 99.95%, or greater than 99.9%, or greater than 99.5%, or greater than 99%, or greater than 90%, or greater than 80%, or greater than 70%, or greater than 60%. In some embodiments, the carbon aggregate has a ratio of carbon to other elements (except for hydrogen) of greater than 99.99%, or greater than 99.95%, or greater than 99.9%, or greater than 99.8%, or greater than 99.5%, or greater than 99%, or greater than 90%, or greater than 80%, or greater than 70%, or greater than 60%. Of course, carbon aggregates including MWSFs or connected MWSFs may be characterized by a ratio of carbon to metal having any of the foregoing values or being within any of the foregoing exemplary ranges, or a ratio of carbon to metal having value or being within a range between any of the foregoing exemplary ranges, without limitation and without departing from the scope of the presently described inventive concepts.

In some embodiments, a carbon aggregate containing MWSFs or connected MWSFs, as defined above, has a high specific surface area. In some embodiments, the carbon aggregate has a Brunauer, Emmett and Teller (BET) specific surface area from 10 to 200 m²/g, or from 10 to 100 m²/g, or from 10 to 50 m²/g, or from 50 to 200 m²/g, or from 50 to 100 m²/g, or from 10 to 1000 m²/g. Of course, carbon aggregates including MWSFs or connected MWSFs may be characterized by a BET specific surface area having any of the foregoing values or being within any of the foregoing exemplary ranges, or a BET specific surface area characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high electrical conductivity. In some embodiments, a carbon aggregate containing MWSFs or connected MWSFs, as defined above, is compressed into a pellet and the pellet has an electrical conductivity greater than 500 S/m, or greater than 1000 S/m, or greater than 2000 S/m, or greater than 3000 S/m, or greater than 4000 S/m, or greater than 5000 S/m, or greater than 10000 S/m, or greater than 20000 S/m, or greater than 30000 S/m, or greater than 40000 S/m, or greater than 50000 S/m, or greater than 60000 S/m, or greater than 70000 S/m, or from 500 S/m to 100000 S/m, or from 500 S/m to 1000 S/m, or from 500 S/m to 10000 S/m, or from 500 S/m to 20000 S/m, or from 500 S/m to 100000 S/m, or from 1000 S/m to 10000 S/m, or from 1000 S/m to 20000 S/m, or from 10000 to 100000 S/m, or from 10000 S/m to 80000 S/m, or from 500 S/m to 10000 S/m. Of course, carbon aggregates including MWSFs or connected MWSFs may be characterized by an electrical conductivity having any of the foregoing values or being within any of the foregoing exemplary ranges, or an electrical conductivity characterized by having a value or being within a range between any of the foregoing exemplary ranges, without limitation and without departing from the scope of the presently described inventive concepts.

In some cases, the density of the pellet is approximately 1 g/cm³, or approximately 1.2 g/cm³, or approximately 1.5 g/cm³, or approximately 2 g/cm³, or approximately 2.2 g/cm³, or approximately 2.5 g/cm³, or approximately 3 g/cm³. Of course, pellets may be characterized by a density having any of the foregoing values or being within any of the foregoing exemplary ranges, or a density having a value or being within a range between any of the foregoing exemplary ranges, without limitation and without departing from the scope of the presently described inventive concepts.

Additionally, tests have been performed in which compressed pellets of the carbon aggregate materials have been formed with compressions of 2000 psi and 12000 psi and with annealing temperatures of 800° C. and 1000° C. The higher compression and/or the higher annealing temperatures generally result in pellets with a higher degree of electrical conductivity, including in the range of 12410.0 S/m to 13173.3 S/m.

### High Purity Carbon Allotropes Produced Using Thermal Processing Systems

In some embodiments, the carbon nanoparticles and aggregates described herein are produced using thermal reactors and methods, such as any appropriate thermal reactor and/or method. Further details pertaining to thermal reactors and/or methods of use can be found in U.S. Pat. No. 9,862,602, issued Jan. 9, 2018, titled “CRACKING OF A PROCESS GAS”, which is hereby incorporated by reference in its entirety. Additionally, precursors (e.g., including methane, ethane, propane, butane, and natural gas) can be used with the thermal reactors to produce the carbon nanoparticles and the carbon aggregates described herein.

In some embodiments, the carbon nanoparticles and aggregates described herein are produced using the thermal reactors with gas flow rates from 1 slm to 10 slm, or from 0.1 slm to 20 slm, or from 1 slm to 5 slm, or from 5 slm to 10 slm, or greater than 1 slm, or greater than 5 slm. In some embodiments, the carbon nanoparticles and aggregates described herein are produced using the thermal reactors with gas resonance times from 0.1 seconds to 30 seconds, or from 0.1 seconds to 10 seconds, or from 1 seconds to 10 seconds, or from 1 seconds to 5 seconds, from 5 seconds to 10 seconds, or greater than 0.1 seconds, or greater than 1 seconds, or greater than 5 seconds, or less than 30 seconds. Of course, carbon nanoparticles and aggregates may be produced using thermal reactors with gas flow rates having any of the foregoing values or being within any of the foregoing exemplary ranges, or gas flow rates having a value or being within a range between any of the foregoing exemplary ranges, without limitation and without departing from the scope of the presently described inventive concepts.

In some embodiments, the carbon nanoparticles and aggregates described herein are produced using the thermal reactors with production rates from 10 g/hr to 200 g/hr, or from 30 g/hr to 200 g/hr, or from 30 g/hr to 100 g/hr, or from 30 g/hr to 60 g/hr, or from 10 g/hr to 100 g/hr, or greater than 10 g/hr, or greater than 30 g/hr, or greater than 100 g/hr. Of course, carbon nanoparticles and aggregates may be produced using thermal reactors with production rates having any of the foregoing values or being within any of the foregoing exemplary ranges, or production rates having a value or being within a range between any of the foregoing exemplary ranges, without limitation and without departing from the scope of the presently described inventive concepts.

In some embodiments, thermal reactors or other cracking apparatuses and thermal reactor methods or other cracking methods can be used for refining, pyrolizing, dissociating or cracking feedstock process gases into its constituents to produce the carbon nanoparticles and the carbon aggregates described herein, as well as other solid and/or gaseous products (e.g., hydrogen gas and/or lower order hydrocarbon gases). The feedstock process gases generally include, for example, hydrogen gas (H₂), carbon dioxide (CO₂), C₁ to C₁₀ hydrocarbons, aromatic hydrocarbons, and/or other hydrocarbon gases such as natural gas, methane, ethane, propane, butane, isobutane, saturated/unsaturated hydrocarbon gases, ethene, propene, etc., and mixtures thereof. The carbon nanoparticles and the carbon aggregates can include, for example, multi-walled spherical fullerenes (MWSFs), connected MWSFs, carbon nanospheres, graphene, graphite, highly ordered pyrolytic graphite, single-walled nanotubes, multi-walled nanotubes, other solid carbon products, and/or the carbon nanoparticles and the carbon aggregates described herein.

Some embodiments for producing the carbon nanoparticles and the carbon aggregates described herein include thermal cracking methods that use, for example, an elongated longitudinal heating element optionally enclosed within an elongated casing, housing or body of a thermal cracking apparatus. The body generally includes, for example, one or more tubes or other appropriate enclosures made of stainless steel, titanium, graphite, quartz, or the like. In some embodiments, the body of the thermal cracking apparatus is generally cylindrical in shape with a central elongate longitudinal axis arranged vertically and a feedstock process gas inlet at or near a top of the body. The feedstock process gas flows longitudinally down through the body or a portion thereof. In the vertical configuration, both gas flow and gravity assist in the removal of the solid products from the body of the thermal cracking apparatus.

The heating element generally includes, for example, a heating lamp, one or more resistive wires or filaments (or twisted wires), metal filaments, metallic strips or rods, and/or other appropriate thermal radical generators or elements that can be heated to a specific temperature (i.e., a molecular cracking temperature) sufficient to thermally crack molecules of the feedstock process gas. The heating element is generally disposed, located or arranged to extend centrally within the body of the thermal cracking apparatus along the central longitudinal axis thereof. For example, if there is only one heating element, then it is placed at or concentric with the central longitudinal axis, and if there is a plurality of the heating elements, then they are spaced or offset generally symmetrically or concentrically at locations near and around and parallel to the central longitudinal axis.

Thermal cracking to produce the carbon nanoparticles and aggregates described herein is generally achieved by passing the feedstock process gas over, or in contact with, or within the vicinity of, the heating element within a longitudinal elongated reaction zone generated by heat from the heating element and defined by and contained inside the body of the thermal cracking apparatus to heat the feedstock process gas to or at a specific molecular cracking temperature.

The reaction zone is considered to be the region surrounding the heating element and close enough to the heating element for the feedstock process gas to receive sufficient heat to thermally crack the molecules thereof. The reaction zone is thus generally axially aligned or concentric with the central longitudinal axis of the body. In some embodiments, the thermal cracking is performed under a specific pressure. In some embodiments, the feedstock process gas is circulated around or across the outside surface of a container of the reaction zone or a heating chamber in order to cool the container or chamber and preheat the feedstock process gas before flowing the feedstock process gas into the reaction zone.

In some embodiments, the carbon nanoparticles and aggregates described herein and/or hydrogen gas are produced without the use of catalysts. In other words, the process is catalyst free.

Some embodiments to produce the carbon nanoparticles and aggregates described herein using thermal cracking apparatuses and methods to provide a standalone system that can advantageously be rapidly scaled up or scaled down for different production levels as desired. For example, some embodiments are scalable to provide a standalone hydrogen and/or carbon nanoparticle producing station, a hydrocarbon source, or a fuel cell station. Some embodiments can be scaled up to provide higher capacity systems, e.g., for a refinery or the like.

In some embodiments, a thermal cracking apparatus for cracking a feedstock process gas to produce the carbon nanoparticles and aggregates described herein include a body, a feedstock process gas inlet, and an elongated heating element. The body has an inner volume with a longitudinal axis. The inner volume has a reaction zone concentric with the longitudinal axis. A feedstock process gas is flowed into the inner volume through the feedstock process gas inlet during thermal cracking operations. The elongated heating element is disposed within the inner volume along the longitudinal axis and is surrounded by the reaction zone. During the thermal cracking operations, the elongated heating element is heated by electrical power to a molecular cracking temperature to generate the reaction zone, the feedstock process gas is heated by heat from the elongated heating element, and the heat thermally cracks molecules of the feedstock process gas that are within the reaction zone into constituents of the molecules.

In some embodiments, a method for cracking a feedstock process gas to produce the carbon nanoparticles and aggregates described herein includes: (1) providing a thermal cracking apparatus having an inner volume that has a longitudinal axis and an elongated heating element disposed within the inner volume along the longitudinal axis; (2) heating the elongated heating element by electrical power to a molecular cracking temperature to generate a longitudinal elongated reaction zone within the inner volume; (3) flowing a feedstock process gas into the inner volume and through the longitudinal elongated reaction zone (e.g., wherein the feedstock process gas is heated by heat from the elongated heating element); and (4) thermally cracking molecules of the feedstock process gas within the longitudinal elongated reaction zone into constituents thereof (e.g., hydrogen gas and one or more solid products) as the feedstock process gas flows through the longitudinal elongated reaction zone.

In some embodiments, the feedstock process gas to produce the carbon nanoparticles and aggregates described herein includes a hydrocarbon gas. The results of cracking include hydrogen (e.g., H²) and various forms of the carbon nanoparticles and aggregates described herein. In some embodiments, the carbon nanoparticles and aggregates include two or more MWSFs and layers of graphene coating the MWSFs, and/or connected MWSFs and layers of graphene coating the connected MWSFs. In some embodiments, the feedstock process gas is preheated (e.g., to 100° C. to 500° C.) by flowing the feedstock process gas through a gas preheating region between a heating chamber and a shell of the thermal cracking apparatus before flowing the feedstock process gas into the inner volume. In some embodiments, a gas having nanoparticles therein is flowed into the inner volume and through the longitudinal elongated reaction zone to mix with the feedstock process gas, and a coating of a solid product (e.g., layers of graphene) is formed around the nanoparticles.

### Post-Processing High Purity Structured Carbons

In some embodiments, the carbon nanoparticles and aggregates containing multi-walled spherical fullerenes (MWSFs) or connected MWSFs described herein are produced and collected, and no post-processing is done. In other embodiments, the carbon nanoparticles and aggregates containing multi-walled spherical fullerenes (MWSFs) or connected MWSFs described herein are produced and collected, and some post-processing is done. Some examples of post-processing involved in the present disclosure include mechanical processing such as ball milling, grinding, attrition milling, micro fluidizing, and other techniques to reduce the particle size without damaging the MWSFs. Some further examples of post-processing include exfoliation processes such as sheer mixing, chemical etching, oxidizing (e.g., Hummer method), thermal annealing, doping by adding elements during annealing (e.g., sulfur, nitrogen), steaming, filtering, and lyophilizing, among others. Some examples of post-processing include sintering processes such as spark plasma sintering (SPS), direct current sintering, microwave sintering, and ultraviolet (UV) sintering, which can be conducted at high pressure and temperature in an inert gas. In some embodiments, multiple post-processing methods can be used together or in a series. In some embodiments, the post-processing produces functionalized carbon nanoparticles or aggregates containing multi-walled spherical fullerenes (MWSFs) or connected MWSFs.

In some embodiments, the materials are mixed together in different combinations. In some embodiments, different carbon nanoparticles and aggregates containing MWSFs or connected MWSFs described herein are mixed together before post-processing. For example, different carbon nanoparticles and aggregates containing MWSFs or connected MWSFs with different properties (e.g., different sizes, different compositions, different purities, from different processing runs, etc.) can be mixed together. In some embodiments, the carbon nanoparticles and aggregates containing MWSFs or connected MWSFs described herein can be mixed with graphene to change the ratio of the connected MWSFs to graphene in the mixture. In some embodiments, different carbon nanoparticles and aggregates containing MWSFs or connected MWSFs described herein can be mixed together after post-processing. For example, different carbon nanoparticles and aggregates containing MWSFs or connected MWSFs with different properties and/or different post-processing methods (e.g., different sizes, different compositions, different functionality, different surface properties, different surface areas) can be mixed together.

In some embodiments, the carbon nanoparticles and aggregates described herein are produced and collected, and subsequently processed by mechanical grinding, milling, and/or exfoliating. In some embodiments, the processing (e.g., by mechanical grinding, milling, exfoliating, etc.) reduces the average size of the particles. In some embodiments, the processing (e.g., by mechanical grinding, milling, exfoliating, etc.) increases the average surface area of the particles. In some embodiments, the processing by mechanical grinding, milling and/or exfoliation shears off some fraction of the carbon layers, producing sheets of graphite mixed with the carbon nanoparticles.

In some embodiments, the mechanical grinding or milling is performed using a ball mill, a planetary mill, a rod mill, a shear mixer, a high-shear granulator, an autogenous mill, or other types of machining used to break solid materials into smaller pieces by grinding, crushing or cutting. In some embodiments, the mechanical grinding, milling and/or exfoliating is performed wet or dry. In some embodiments, the mechanical grinding is performed by grinding for some period of time, then idling for some period of time, and repeating the grinding and idling for a number of cycles. In some embodiments, the grinding period is from 1 minute to 20 minutes, or from 1 minute to 10 minutes, or from 3 minutes to 8 minutes, or approximately 3 minutes, or approximately 8 minutes. In some embodiments, the idling period is from 1 minute to 10 minutes, or approximately 5 minutes, or approximately 6 minutes. In some embodiments, the number of grinding and idling cycles is from 1 minute to 100 minutes, or from 5 minutes to 100 minutes, or from 10 minutes to 100 minutes, or from 5 minutes to 10 minutes, or from 5 minutes to 20 minutes. In some embodiments, the total amount of time of grinding and idling is from 10 minutes to 1200 minutes, or from 10 minutes to 600 minutes, or from 10 minutes to 240 minutes, or from 10 minutes to 120 minutes, or from 100 minutes to 90 minutes, or from 10 minutes to 60 minutes, or approximately 90 minutes, or approximately 120 minutes. Of course, grinding, milling, or idling times within the scope of the presently disclosed inventive embodiments may have any of the foregoing values or be within any of the foregoing exemplary ranges, between any of the foregoing exemplary ranges, without limitation and without departing from the scope of the presently described inventive concepts.

In some embodiments, the grinding steps in the cycle are performed by rotating a mill in one direction for a first cycle (e.g., clockwise), and then rotating a mill in the opposite direction (e.g., counterclockwise) for the next cycle. In some embodiments, the mechanical grinding or milling is performed using a ball mill, and the grinding steps are performed using a rotation speed from 100 to 1000 rpm, or from 100 to 500 rpm, or approximately 400 rpm, or any value or range of values therebetween. In some embodiments, the mechanical grinding or milling is performed using a ball mill that uses a milling media with a diameter from 0.1 mm to 20 mm, or from 0.1 mm to 10 mm, or from 1 mm to 10 mm, or approximately 0.1 mm, or approximately 1 mm, or approximately 10 mm, or any value or range of values therebetween. In some embodiments, the mechanical grinding or milling is performed using a ball mill that uses a milling media composed of metal such as steel, an oxide such as zirconium oxide (zirconia), yttria stabilized zirconium oxide, silica, alumina, magnesium oxide, or other hard materials such as silicon carbide or tungsten carbide.

In some embodiments, the carbon nanoparticles and aggregates described herein are produced and collected, and subsequently processed using elevated temperatures such as thermal annealing or sintering. In some embodiments, the processing using elevated temperatures is done in an inert environment such as nitrogen or argon. In some embodiments, the processing using elevated temperatures is done at atmospheric pressure, or under vacuum, or at low pressure. In some embodiments, the processing using elevated temperatures is done at a temperature from 500° C. to 2500° C., or from 500° C. to 1500° C., or from 800° C. to 1500° C., or from 800° C. to 1200° C., or from 800° C. to 1000° C., or from 2000° C. to 2400° C., or approximately 800° C., or approximately 1000° C., or approximately 1500° C., or approximately 2000° C., or approximately 2400° C. Of course, processing using elevated temperatures may be performed at any of the foregoing temperatures, or at a temperature within any of the foregoing exemplary ranges, or between any of the foregoing exemplary ranges, without limitation and without departing from the scope of the presently described inventive concepts.

In some embodiments, the carbon nanoparticles and aggregates described herein are produced and collected, and subsequently, in post processing steps, additional elements or compounds are added to the carbon nanoparticles, thereby incorporating the unique properties of the carbon nanoparticles and aggregates into other mixtures of materials.

In some embodiments, either before or after post-processing, the carbon nanoparticles and aggregates described herein are added to solids, liquids or slurries of other elements or compounds to form additional mixtures of materials incorporating the unique properties of the carbon nanoparticles and aggregates. In some embodiments, the carbon nanoparticles and aggregates described herein are mixed with other solid particles, polymers or other materials.

In some embodiments, either before or after post-processing, the carbon nanoparticles and aggregates described herein are used in various applications beyond applications pertaining to the present disclosure. Such applications including but not limited to transportation applications (e.g., automobile and truck tires, couplings, mounts, elastomeric o-rings, hoses, sealants, grommets, etc.) and industrial applications (e.g., rubber additives, functionalized additives for polymeric materials, additives for epoxies, etc.).

FIG. 20A and 20B show transmission electron microscope (TEM) images of as-synthesized carbon nanoparticles. The carbon nanoparticles of FIG. 20A (at a first magnification) and FIG. 20B (at a second magnification) contain connected multi-walled spherical fullerenes 2002 (MWSFs) with graphene layers 2004 that coat the connected MWSFs. The ratio of MWSF to graphene allotropes in this example is approximately 80% due to the relatively short resonance times. The MWSFs in FIG. 20A are approximately 5 nm to 10 nm in diameter, and the diameter can be from 5 nm to 500 nm using the conditions described above. In some embodiments, the average diameter across the MWSFs is in a range from 5 nm to 500 nm, or from 5 nm to 250 nm, or from 5 nm to 100 nm, or from 5 nm to 50 nm, or from 10 nm to 500 nm, or from 10 nm to 250 nm, or from 10 nm to 100 nm, or from 10 nm to 50 nm, or from 40 nm to 500 nm, or from 40 nm to 250 nm, or from 40 nm to 100 nm, or from 50 nm to 500 nm, or from 50 nm to 250 nm, or from 50 nm to 100 nm. Of course, average MWSF diameter within the scope of the presently disclosed inventive embodiments may have any of the foregoing values or be within any of the foregoing exemplary ranges, or between any of the foregoing exemplary ranges, without limitation and without departing from the scope of the presently described inventive concepts. No catalyst was used in this process, and therefore, there is no central seed containing contaminants. The aggregate particles produced in this example had a particle size of approximately 10 μm to 100 μm, or approximately 10 μm to 500 μm.

FIG. 20C shows the Raman spectrum of the as-synthesized aggregates in this example taken with 532 nm incident light. The I_{D}/I_{G} for the aggregates produced in this example is from approximately 0.99 to 1.03, indicating that the aggregates were composed of carbon allotropes with a high degree of order.

FIG. 20D and FIG. 20E show example TEM images of the carbon nanoparticles after size reduction by grinding in a ball mill. The ball milling was performed in cycles with a 3 minute counter-clockwise grinding step, followed by a 6 minute idle step, followed by a 3 minute clockwise grinding step, followed by a 6 minute idle step. The grinding steps were performed using a rotation speed of 400 rpm. The milling media was zirconia and ranged in size from 0.1 mm to 10 mm. The total size reduction processing time was from 60 minutes to 120 minutes. After size reduction, the aggregate particles produced in this example had a particle size of approximately 1 μm to 5 μm. The carbon nanoparticles after size reduction are connected MWSFs with layers of graphene coating the connected MWSFs.

FIG. 20F shows a Raman spectrum from these aggregates after size reduction taken with a 532 nm incident light. The I_{D}/I_{G} for the aggregate particles in this example after size reduction is approximately 1.04. Additionally, the particles after size reduction had a Brunauer, Emmett and Teller (BET) specific surface area of approximately 40 m²/g to 50 m²/g.

The purity of the aggregates produced in this sample were measured using mass spectrometry and x-ray fluorescence (XRF) spectroscopy. The ratio of carbon to other elements, except for hydrogen, measured in 16 different batches was from 99.86% to 99.98%, with an average of 99.94% carbon.

In this example, carbon nanoparticles were generated using a thermal hot-wire processing system. The precursor material was methane, which was flowed from 1 slm to 5 slm. With these flow rates and the tool geometry, the resonance time of the gas in the reaction chamber was from approximately 20 second to 30 seconds, and the carbon particle production rate was from approximately 20 g/hr.

Further details pertaining to such a processing system can be found in the previously mentioned U.S. Pat. No. 9,862,602, titled “CRACKING OF A PROCESS GAS.”

FIG. 20G, FIG. 20H and FIG. 20I show TEM images of as-synthesized carbon nanoparticles of this example. The carbon nanoparticles contain connected multi-walled spherical fullerenes (MWSFs) with layers of graphene coating the connected MWSFs. The ratio of multi-walled fullerenes to graphene allotropes in this example is approximately 30% due to the relatively long resonance times allowing thicker, or more, layers of graphene to coat the MWSFs. No catalyst was used in this process, and therefore, there is no central seed containing contaminants. The as-synthesized aggregate particles produced in this example had particle sizes of approximately 10 μm to 500 μm. FIG. 20J shows a Raman spectrum from the aggregates of this example. The Raman signature of the as-synthesized particles in this example is indicative of the thicker graphene layers which coat the MWSFs in the as-synthesized material. Additionally, the as-synthesized particles had a Brunauer, Emmett and Teller (BET) specific surface area of approximately 90 m²/g to 100 m²/g.

FIG. 20K and FIG. 20L show TEM images of the carbon nanoparticles of this example. Specifically, the images depict the carbon nanoparticles after performance of size reduction by grinding in a ball mill. The size reduction process conditions were the same as those described as pertains to the foregoing FIG. 20G through FIG. 20J. After size reduction, the aggregate particles produced in this example had a particle size of approximately 1 μm to 5 μm. The TEM images show that the connected MWSFs that were buried in the graphene coating can be observed after size reduction. FIG. 20M shows a Raman spectrum from the aggregates of this example after size reduction taken with 532 nm incident light. The I_{D}/I_{G} for the aggregate particles in this example after size reduction is approximately 1, indicating that the connected MWSFs that were buried in the graphene coating as-synthesized had become detectable in Raman after size reduction, and were well ordered. The particles after size reduction had a Brunauer, Emmett and Teller (BET) specific surface area of approximately 90 m²/g to 100 m²/g.

FIG. 20N is a scanning electron microscope (SEM) image of carbon aggregates showing the graphite and graphene allotropes at a first magnification. FIG. 20O is a SEM image of carbon aggregates showing the graphite and graphene allotropes at a second magnification. The layered graphene is clearly shown within the distortion (wrinkles) of the carbon. The 3D structure of the carbon allotropes is also visible.

The particle size distribution of the carbon particles of FIG. 20N and FIG. 20O is shown in FIG. 20P. The mass basis cumulative particle size distribution 2006 corresponds to the left y-axis in the graph (Q³(x) [%]). The histogram of the mass particle size distribution 2008 corresponds to the right axis in the graph (dQ³(x) [%]). The median particle size is approximately 33 μm. The 10th percentile particle size is approximately 9 μm, and the 90th percentile particle size is approximately 103 μm. The mass density of the particles is approximately 10 g/L.

The particle size distribution of the carbon particles captured from a multiple-stage reactor is shown in FIG. 20Q. The mass basis cumulative particle size distribution 2014 corresponds to the left y-axis in the graph (Q³(x) [%]). The histogram of the mass particle size distribution 2016 corresponds to the right axis in the graph (dQ³(x) [%]). The median particle size captured is approximately 11 μm. The 10th percentile particle size is approximately 3.5 μm, and the 90th percentile particle size is approximately 21 μm. The graph in FIG. 20Q also shows the number basis cumulative particle size distribution 2018 corresponding to the left y-axis in the graph (Q⁰(x) [%]). The median particle size by number basis is from approximately 0.1 μm to approximately 0.2 μm. The mass density of the particles collected is approximately 22 g/L.

Returning to the discussion of FIG. 20P, the graph also shows a second set of example results. Specifically, in this example, the particles were size-reduced by mechanical grinding, and then the size-reduced particles were processed using a cyclone separator. The mass basis cumulative particle size distribution 2010 of the size-reduced carbon particles captured in this example corresponds to the left y-axis in the graph (Q³(x) [%]). The histogram of the mass basis particle size distribution 2012 corresponds to the right axis in the graph (dQ³(x) [%]). The median particle size of the size-reduced carbon particles captured in this example is approximately 6 μm. The 10th percentile particle size is from 1 μm to 2 μm, and the 90th percentile particle size is from 10 μm to 20 μm.

Further details pertaining to making and using cyclone separators can be found in U.S. patent application Ser. No. 15/725,928, filed Oct. 5, 2017, titled “MICROWAVE REACTOR SYSTEM WITH GAS-SOLIDS SEPARATION”, which is hereby incorporated by reference in its entirety.

### High Purity Carbon Allotropes Produced Using Microwave Reactor Systems

In some cases, carbon particles and aggregates containing graphite, graphene and amorphous carbon can be generated using a microwave plasma reactor system using a precursor material that contains methane, or contains isopropyl alcohol (IPA), or contains ethanol, or contains a condensed hydrocarbon (e.g., hexane). In some other examples, the carbon-containing precursors are optionally mixed with a supply gas (e.g., argon). The particles produced in this example contained graphite, graphene, amorphous carbon and no seed particles. The particles in this example had a ratio of carbon to other elements (other than hydrogen) of approximately 99.5% or greater.

In one particular example, a hydrocarbon was the input material for the microwave plasma reactor, and the separated outputs of the reactor comprised hydrogen gas and carbon particles containing graphite, graphene and amorphous carbon. The carbon particles were separated from the hydrogen gas in a multi-stage gas-solid separation system. The solids loading of the separated outputs from the reactor was from 0.001 g/L to 2.5 g/L.

FIG. 20R, FIG. 20S, and FIG. 20T are TEM images of as-synthesized carbon nanoparticles. The images show examples of graphite, graphene and amorphous carbon allotropes. The layers of graphene and other carbon materials can be clearly seen in the images.

The particle size distribution of the carbon particles captured is shown in FIG. 20U. The mass basis cumulative particle size distribution 2020 corresponds to the left y-axis in the graph (Q³(x) [%]). The histogram of the mass particle size distribution 2022 corresponds to the right axis in the graph (dQ³(x) [%]). The median particle size captured in the cyclone separator in this example was approximately 14 μm. The 10th percentile particle size was approximately 5 μm, and the 90th percentile particle size was approximately 28 μm. The graph in FIG. 20U also shows the number basis cumulative particle size distribution 2024 corresponding to the left y-axis in the graph (Q⁰(x) [%]). The median particle size by number basis in this example was from approximately 0.1 μm to approximately 0.2 μm.

FIG. 20V, FIG. 20W, and FIG. 20X, and 20Y are images that show three-dimensional carbon-containing structures that are grown onto other three-dimensional structures. FIG. 20V is a 100× magnification of three-dimensional carbon structures grown onto carbon fibers, whereas FIG. 20W is a 200× magnification of three-dimensional carbon structures grown onto carbon fibers. FIG. 20X is a 10000× magnification of three-dimensional carbon structures grown onto carbon fibers. The three-dimensional carbon growth over the fiber surface is shown. FIG. 20Y is a 10000× magnification of three-dimensional carbon structures grown onto carbon fibers. The image depicts growth onto the basal plane as well as onto edge planes.

More specifically, FIGS. 20V-20Y show example SEM images of 3D carbon materials grown onto fibers using plasma energy from a microwave plasma reactor as well as thermal energy from a thermal reactor. FIG. 20V shows an SEM image of intersecting fibers 2031 and 2032 with 3D carbon material 2030 grown on the surface of the fibers. FIG. 20W is a higher magnification image (the scale bar is 300 μm compared to 500 μm for FIG. 20V) showing 3D carbon growth 2030 on the fiber 2032. FIG. 20X is a further magnified view (scale bar is 40 μm) showing 3D carbon growth 2030 on fiber surface 2035, where the 3D nature of the carbon growth 2030 can be clearly seen. FIG. 20Y shows a close-up view (scale bar is 500 nm) of the carbon alone, showing interconnection between basal planes 2036 and edge planes 2034 of numerous sub-particles of the 3D carbon material grown on the fiber. FIGS. 20V-20Y demonstrate the ability to grow 3D carbon on a 3D fiber structure according to some embodiments, such as 3D carbon growth grown on a 3D carbon fiber.

In some embodiments, 3D carbon growth on fibers can be achieved by introducing a plurality of fibers into the microwave plasma reactor and using plasma in the microwave reactor to etch the fibers. The etching creates nucleation sites such that when carbon particles and sub-particles are created by hydrocarbon disassociation in the reactor, growth of 3D carbon structures is initiated at these nucleation sites. The direct growth of the 3D carbon structures on the fibers, which themselves are three-dimensional in nature, provides a highly integrated, 3D structure with pores into which resin can permeate. This 3D reinforcement matrix (including the 3D carbon structures integrated with high aspect ratio reinforcing fibers) for a resin composite results in enhanced material properties, such as tensile strength and shear, compared to composites with conventional fibers that have smooth surfaces and which smooth surfaces typically delaminate from the resin matrix.

### Functionalizing Carbon

In some embodiments, carbon materials, such as 3D carbon materials described herein, can be functionalized to promote adhesion and/or add elements such as oxygen, nitrogen, carbon, silicon, or hardening agents. In some embodiments, the carbon materials can be functionalized in situ—that is, within the same reactor in which the carbon materials are produced. In some embodiments, the carbon materials can be functionalized in post-processing. For example, the surfaces of fullerenes or graphene can be functionalized with oxygen- or nitrogen-containing species which form bonds with polymers of the resin matrix, thus improving adhesion and providing strong binding to enhance the strength of composites.

Embodiments include functionalizing surface treatments for carbon (e.g., CNTs, CNO, graphene, 3D carbon materials such as 3D graphene) utilizing plasma reactors (e.g., microwave plasma reactors) described herein. Various embodiments can include in situ surface treatment during creation of carbon materials that can be combined with a binder or polymer in a composite material. Various embodiments can include surface treatment after creation of the carbon materials while the carbon materials are still within the reactor.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for producing graphene quantum dots, comprising:
a reactor configured to generate a carbonaceous material;
a sonication device configured to mix the carbonaceous material with a solvent to form a mixture;
a filtration device configured to filter the sonicated mixture; and
a collection vessel configured to receive a filtrate containing graphene quantum dots from the filtration device.

2. The system of claim 1, wherein the reactor is a thermal reactor.

3. The system of claim 1, wherein the carbonaceous material comprises reactor carbon.

4. The system of claim 1, wherein the solvent comprises toluene.

5. The system of claim 1, wherein the sonication device comprises a water bath sonicator.

6. The system of claim 1, wherein the filtration device comprises a 0.2 μm filter.

7. The system of claim 1, further comprising a dilution device configured to dilute the filtrate to multiple concentrations.

8. The system of claim 7, further comprising an ultraviolet light source configured to illuminate the diluted filtrate samples.

9. The system of claim 1, further comprising an evaporation device configured to evaporate solvent from a portion of the filtrate to obtain a residue.

10. The system of claim 9, further comprising a re-dispersion device configured to re-disperse the residue in isopropyl alcohol.

11. The system of claim 10, further comprising a transmission electron microscope configured to analyze the re-dispersed mixture.

12. The system of claim 1, wherein the graphene quantum dots have a size between 1-100 nm.

13. The system of claim 1, wherein the graphene quantum dots exhibit fluorescence when exposed to ultraviolet light.

14. The system of claim 1, further comprising a waste collection vessel configured to collect unwanted components separated from the carbonaceous material.

15. The system of claim 14, wherein the unwanted components comprise polycyclic aromatic hydrocarbons (PAHs) oils and low molecular weight solids.

16. The system of claim 1, further comprising a cold trap configured to collect hydrophobic quantum dots.

17. The system of claim 16, further comprising a dispersion device configured to disperse the hydrophobic quantum dots in a variety of solvents.

18. The system of claim 1, further comprising a characterization device configured to analyze the graphene quantum dots.

19. The system of claim 18, wherein the characterization device comprises a fluorescence spectrometer.

20. The system of claim 18, wherein the characterization device comprises an atomic force microscope.

21. The system of claim 1, further comprising a purification device configured to further purify the graphene quantum dots.

22. The system of claim 21, wherein the purification device comprises a centrifuge.

23. The system of claim 1, further comprising a storage device configured to store the graphene quantum dots under controlled environmental conditions.

24. The system of claim 1, further comprising a surface functionalization device configured to modify the surface of the graphene quantum dots.

25. The system of claim 24, wherein the surface functionalization device is configured to attach functional groups to the graphene quantum dots.

26. The system of claim 1, further comprising a size selection device configured to separate graphene quantum dots based on size.

27. The system of claim 26, wherein the size selection device comprises a size exclusion chromatography column or a dialysis bag.

28. The system of claim 1, further comprising a packaging device configured to prepare the graphene quantum dots for storage or transport, or a quality control device configured to assess the purity and uniformity of the graphene quantum dots, wherein the quality control device comprises a dynamic light scattering instrument.

29. A method of producing graphene quantum dots, comprising:
obtaining a carbonaceous material from a reactor;
adding a solvent to the carbonaceous material to form a mixture;
sonicating the mixture;
filtering the sonicated mixture to obtain a filtrate; and
collecting the filtrate containing graphene quantum dots.

30. The method of claim 29, wherein at least one of:
the carbonaceous material comprises reactor carbon,
the solvent comprises toluene,
sonicating the mixture is performed using a water bath sonicator,
the reactor is a thermal reactor,
the unwanted components comprise polycyclic aromatic hydrocarbons (PAHs) oils and low molecular weight solids, or
filtering the sonicated mixture is performed using a 0.2 μm filter, or
wherein the method further comprises at least one of:
diluting the filtrate to multiple concentrations,
observing fluorescence of the diluted filtrate samples under ultraviolet light,
evaporating solvent from a portion of the filtrate to obtain a residue,
re-dispersing the residue in isopropyl alcohol,
analyzing the re-dispersed mixture via transmission electron microscopy,
collecting unwanted components separated from the carbonaceous material,
collecting hydrophobic quantum dots using a cold trap,
dispersing the hydrophobic quantum dots in a variety of solvents,
characterizing the graphene quantum dots using a fluorescence spectrometer,
characterizing the graphene quantum dots using an atomic force microscope,
purifying the graphene quantum dots using a centrifuge,
storing the graphene quantum dots under controlled environmental conditions,
modifying the surface of the graphene quantum dots by attaching functional groups,
separating the graphene quantum dots based on size using a size exclusion chromatography column or a dialysis bag,
packaging the graphene quantum dots for storage or transport,
assessing the purity and uniformity of the graphene quantum dots using a dynamic light scattering instrument,
analyzing the graphene quantum dots using Raman spectroscopy,
functionalizing the graphene quantum dots with biomolecules for biological applications,
incorporating the graphene quantum dots into a polymer matrix,
dispersing the graphene quantum dots in at least one of a non-polar solvent, a polar solvent, a co-solvent, or
treating the graphene quantum dots with an oxidizing agent to modify their surface properties, or
wherein the graphene quantum dots have a size between 1-100 nm, or exhibit fluorescence when exposed to ultraviolet light.
